(19) United States
(12) Patent Application Publication
(10) Pub. No.: US 2026/0333104 A1
(43) Pub. Date: Oct. 22, 2026

(54) REQUESTING UPLINK STATUS INFORMATION

(71) Applicant: Lenovo (United States) Inc., Morrisville, NC (US)

(72) Inventors: Joachim Löhr, Wiesbaden (DE); Tapisha Soni, Munich (DE)

(73) Assignee: Lenovo (United States) Inc., Morrisville, NC (US)

(21) Appl. No.: 19/637,807

(22) Filed: Apr. 2, 2026

(51) Int. Cl. H04W 24/10; H04W 52/36; H04W 72/1268

(52) U.S. Cl. CPC H04W 24/10; H04W 52/365; H04W 72/1268

(57) ABSTRACT

Various aspects of the present disclosure relate to requesting uplink status information. A user equipment (UE) may receive, from a network entity (NE), control information including a field indicating a request for information associated with an uplink status to be reported for the UE. The field may further indicate a type of the uplink status corresponding to a current uplink status or a predicted uplink status. The UE may transmit, to the NE and in response to the control information, an uplink status report comprising the information in accordance with the indicated type of the uplink status. The NE may compare the uplink status report for the current uplink status with a previously received uplink status report for the predicted uplink status to determine a prediction accuracy metric. In some examples, the control information may be signaled within downlink control information (DCI) via a physical downlink control channel (PDCCH).

### TECHNICAL FIELD

The present disclosure relates to wireless communications, and more specifically to uplink traffic management.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive control information including a field indicating a request for information associated with an uplink status to be reported for the UE, where the field further indicates a type of the uplink status corresponding to a current uplink status or a predicted uplink status, and transmit, in response to the control information, an uplink status report including the information in accordance with the indicated type of the uplink status.

A processor (e.g., a standalone processor chipset, or a component of a UE) for wireless communication is described. The processor may be configured to, capable of, or operable to perform one or more operations as described herein. For example, the processor may be configured to, capable of, or operable to receive control information including a field indicating a request for information associated with an uplink status to be reported for the UE, where the field further indicates a type of the uplink status corresponding to a current uplink status or a predicted uplink status, and transmit, in response to the control information, an uplink status report including the information in accordance with the indicated type of the uplink status.

A method performed or performable by a UE for wireless communication is described. The method may include receiving control information including a field indicating a request for information associated with an uplink status to be reported for the UE, where the field further indicates a type of the uplink status corresponding to a current uplink status or a predicted uplink status, and transmitting, in response to the control information, an uplink status report including the information in accordance with the indicated type of the uplink status.

In some implementations of the UE, the processor, and the method described herein, the control information is signaled within downlink control information (DCI) via a physical downlink control channel (PDCCH). In some implementations of the UE, the processor, and the method described herein, the control information further indicates uplink resources for transmission of the uplink status report, and the uplink status report is transmitted on the indicated uplink resources. In some implementations of the UE, the processor, and the method described herein, the control information is signaled within a medium access control (MAC) control element (MAC-CE). In some implementations of the UE, the processor, and the method described herein, the field further indicates a category of the uplink status, the category corresponding to at least one of a buffer status, a delay status, or a power status.

In some implementations of the UE, the processor, and the method described herein, the field includes a set of bits, each bit of the set of bits corresponding to a respective category of the uplink status. In some implementations of the UE, the processor, and the method described herein, the type corresponds to the current uplink status, and the information is calculated based on data currently pending in a layer 2 buffer of the UE. In some implementations of the UE, the processor, and the method described herein, the type corresponds to the predicted uplink status, and the information is predicted for a future time instance based on an inference outcome of a traffic prediction model.

In some implementations of the UE, the processor, and the method described herein, the uplink status includes a power status based on a reference uplink allocation. In some implementations of the UE, the processor, and the method described herein, the reference uplink allocation includes a reference physical uplink shared channel (PUSCH) format configured by the network node, and the UE, the processor, and the method may further be configured to, capable of, or operable to compute a power headroom value for the reference PUSCH format, the power headroom value computed using a maximum power reduction (MPR) value determined by the UE for the reference PUSCH format. In some implementations of the UE, the processor, and the method described herein, the UE, the processor, and the method may further be configured to, capable of, or operable to refrain from transmitting the uplink status report for the current uplink status based on a prior transmission of the uplink status report for the predicted uplink status and receipt of an uplink grant, where the uplink grant is based on the predicted uplink status.

An NE (e.g., a base station) for wireless communication is described. The NE may be configured to, capable of, or operable to perform one or more operations as described herein. For example, the NE may be configured to, capable of, or operable to transmit, to a UE, control information including a field indicating a request for information associated with an uplink status to be reported for the UE, where the field further indicates a type of the uplink status corresponding to a current uplink status or a predicted uplink status, and receive, from the UE, in response to the control information, an uplink status report including the information in accordance with the indicated type of the uplink status.

A processor (e.g., a standalone processor chipset, or a component of an NE) for wireless communication is described. The processor may be configured to, capable of, or operable to perform one or more operations as described herein. For example, the processor may be configured to, capable of, or operable to transmit, to a UE, control information including a field indicating a request for information associated with an uplink status to be reported for the UE, where the field further indicates a type of the uplink status corresponding to a current uplink status or a predicted uplink status, and receive, from the UE, in response to the control information, an uplink status report including the information in accordance with the indicated type of the uplink status.

A method performed or performable by an NE (e.g., a base station) for wireless communication is described. The method may include transmitting, to a UE, control information including a field indicating a request for information associated with an uplink status to be reported for the UE, where the field further indicates a type of the uplink status corresponding to a current uplink status or a predicted uplink status, and receiving, from the UE, in response to the control information, an uplink status report including the information in accordance with the indicated type of the uplink status.

In some implementations of the NE, the processor, and the method described herein, the control information is signaled within DCI via a PDCCH. In some implementations of the NE, the processor, and the method described herein, the control information further indicates uplink resources for reception of the uplink status report, and the uplink status report is received on the indicated uplink resources. In some implementations of the NE, the processor, and the method described herein, the control information is signaled within a MAC-CE. In some implementations of the NE, the processor, and the method described herein, the field further indicates a category of the uplink status, the category corresponding to at least one of a buffer status, a delay status, or a power status.

In some implementations of the NE, the processor, and the method described herein, the NE, the processor, and the method may further be configured to, capable of, or operable to compare the uplink status report for the current uplink status with a previously received uplink status report for the predicted uplink status to determine a prediction accuracy metric. In some implementations of the NE, the processor, and the method described herein, the NE, the processor, and the method may further be configured to, capable of, or operable to adapt a configuration for predictive uplink status reporting at the UE based on the prediction accuracy metric, or disable predictive uplink status reporting at the UE based on the prediction accuracy metric failing to satisfy a threshold.

### BRIEF DESCRIPTION OF THE DRAWINGS

FIG. 1 illustrates an example of a wireless communications system in accordance with aspects of the present disclosure.

FIG. 2 illustrates an example model functional framework, in accordance with aspects of the present disclosure.

FIGS. 3 through 6 illustrate example signaling diagrams, in accordance with aspects of the present disclosure.

FIGS. 7A through 7C illustrate example uplink status report formats, in accordance with aspects of the present disclosure.

FIGS. 8 through 12 illustrate example signaling diagrams, in accordance with aspects of the present disclosure.

FIGS. 13A, 13B, and 13C illustrate example traffic prediction processes, in accordance with aspects of the present disclosure.

FIG. 14 illustrates an example of a UE in accordance with aspects of the present disclosure.

FIG. 15 illustrates an example of a processor in accordance with aspects of the present disclosure.

FIG. 16 illustrates an example of an NE in accordance with aspects of the present disclosure.

FIG. 17 illustrates a flowchart of a method performed by a UE in accordance with aspects of the present disclosure.

FIG. 18 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. The NE may schedule communications to and from the UE by allocating the time-frequency resources based on various parameters. To support uplink scheduling, the UE may report information about its uplink data and power status to the NE. For example, the UE may transmit a buffer status report (BSR) to the NE to indicate the amount of uplink data currently buffered at the UE. However, BSRs are reactive in that they are generated after data arrives at the UE's buffer. This reactive approach introduces latency in the uplink scheduling process, as the NE only becomes aware of the UE's uplink data status after the data has already arrived. For advanced services such as immersive communication, extended reality (XR), and ultra-reliable low-latency communication (URLLC), QoS demands are increasingly stringent, and the challenge of efficiently distributing uplink resources among multiple UEs in a cell becomes more pronounced.

Having advance knowledge of upcoming uplink data traffic at the UE can enhance scheduling decisions at the NE, improving system capacity and QoS fulfillment. To address this, traffic prediction may be performed at the UE to forecast uplink data arrivals and provide the NE with predicted uplink status information in advance of the data arriving at the UE's buffer. In some examples, AI/ML models may be applied at the UE for traffic prediction. In some other examples, predictions may be generated using non-AI/ML methods such as application layer knowledge (e.g., periodic sensor reporting patterns or periodic XR frame generation), recent packet arrival statistics (e.g., inter-arrival times or burst size distributions), or higher-layer indications from applications or middleware (e.g., explicit announcements of upcoming bursts or changes in QoS). If the NE relies on such predictions for scheduling, however, the NE may also need to evaluate the accuracy of the UE's predictions. Conventional approaches lack mechanisms for the NE to perform such evaluation. For example, unused uplink grants could result from many causes, such as quantization error of buffer status tables, discarding of protocol data units (PDUs) at the UE before transmission, or inaccurate predictions. As a result, the NE cannot unambiguously determine whether predictions are accurate based solely on resource utilization.

Accordingly, the techniques described herein provide mechanisms for uplink status reporting that support both current and predicted uplink status information. In some examples, the NE may transmit control information to the UE that requests uplink status information and indicates whether the UE should report its current uplink status or a predicted uplink status. As used herein, a current uplink status (also referred to as an actual uplink status) refers to uplink status information determined based on data currently pending in a buffer of the UE, while a predicted uplink status refers to uplink status information predicted for a future time instance. The predicted uplink status may be based on an inference outcome of a traffic prediction model (e.g., an AI/ML model) or on non-AI/ML methods such as application layer knowledge, packet arrival statistics, or higher-layer indications. The UE generates and transmits an uplink status report in response to the request. Additionally, or alternatively, the NE may transmit a configuration to the UE that defines trigger conditions and a type of uplink status to be reported. The UE autonomously determines when a trigger condition is fulfilled and transmits an uplink status report accordingly.

The uplink status report may include information such as buffer status, delay status, power status, data volume, timing information, or prediction accuracy, and may be reported at various granularities such as per logical channel, per logical channel group, per QoS flow, or per QoS priority class. The NE and/or the UE may evaluate the performance of uplink status predictions by, for example, comparing actual uplink status information with predicted uplink status information. In some examples, the UE may transmit a correction uplink status report when a prediction error metric exceeds a configured threshold, enabling the NE to update its scheduling view.

By providing predicted uplink status information in advance of data arrival, the techniques described herein enable the NE to pre-allocate uplink resources for future transmission occasions, reducing uplink access delay for emerging bursts and enabling proactive QoS assurance. As a further benefit, when the NE has already allocated resources based on a predicted uplink status report, the UE may refrain from transmitting a subsequent current uplink status report for the same reporting granularity. This traffic status cancellation reduces signaling overhead by avoiding redundant reporting when the NE has already received the information it needs for scheduling. Additionally, by enabling the NE to explicitly request actual status reports and compare them with predicted reports, the techniques described herein allow unambiguous evaluation of prediction accuracy without relying on indirect indicators such as resource utilization. Based on the evaluation, the NE can adapt the predictive reporting configuration (e.g., adjusting prediction windows, trigger conditions, or report granularity) or disable predictive reporting for UEs with poor prediction performance, so that prediction-based scheduling is used when it delivers sufficient performance gains. In this manner, the techniques described herein improve scheduling efficiency, reduce latency, and reduce signaling overhead in wireless communications systems that support predictive uplink status reporting.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

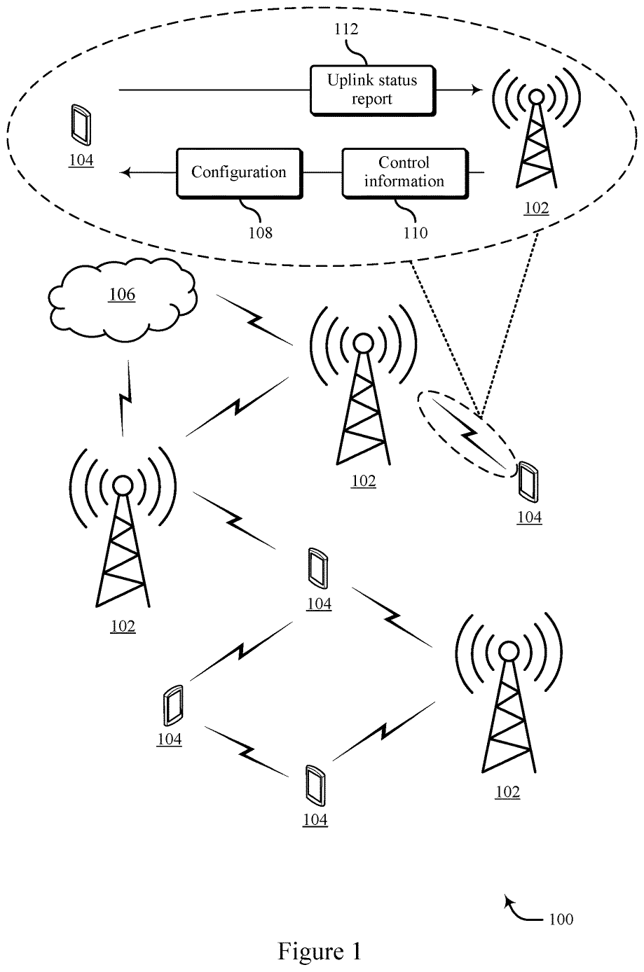

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more devices in the wireless communications system 100 may support models, functionalities, and features/feature groups that are based on or otherwise associated with AI/ML. A network node, such as an NE 102, may manage implementation and operation of one or more models, functionalities, and/or features at one or more UEs 104. For example, the NE 102 may transmit signaling instructing one or more UEs 104 to activate, deactivate, switch between, or fall back from a model or functionality. Additionally, or alternatively, the NE 102 may configure and instruct one or more UEs 104 to perform AI/ML-related tasks, which may include life cycle management (LCM) functions such as data collection. For instance, a UE 104 may perform measurements, collect data, and transfer the data to the NE 102. The NE 102 can transmit, to the UE 104, a configuration for performing the data collection, where the configuration can indicate measurements to be performed, data to be collected, and other parameters. In some cases, a UE 104 can make decisions regarding AI/ML-related tasks, e.g., autonomously or by communicating requests to the NE 102.

An AI/ML feature may be defined as a capability, operation, behavior, procedure, task, etc. that leverages and/or is enabled by AI/ML. As described herein, the term “functionality” refers to an AI/ML feature at a granularity of a use-case or sub-use-case, applied for inference at a node (e.g., a UE 104, an NE 102). In some cases, the granularity of an AI/ML functionality can be at a level of configuration for a particular use-case (e.g., beam management) or sub-use-case (e.g., spatial domain beam management, temporal domain beam management). AI/ML functionalities include, but are not limited to, beamforming, beam management, measurement prediction, CSI prediction, CSI compression, channel estimation, traffic prediction, and positioning, among other examples. A supported AI/ML functionality may be defined as an AI/ML functionality for which a node contains or is capable of downloading one or more AI/ML models, while these models may be generalized or cell-specific.

A network node (e.g., a UE 104, an NE 102) may be capable of supporting multiple AI/ML models, AI/ML features, and AI/ML functionalities/configurations. Additionally, different network nodes may be capable of supporting different combinations of the aforementioned. Thus, to ensure efficient management and operation, a UE 104 may report AI/ML capability-related information (e.g., UE capability information) to the network (e.g., to an NE 102), enabling the network to make appropriate decisions related to activation, deactivation, switching, fallback, and the like. AI/ML capability information can include indications of models, features, and/or functionalities supported by a UE 104. In some examples, a UE 104 reports AI/ML capability information periodically and/or in response to a trigger event, such as reception of a request from the NE 102.

Additionally, a network node (e.g., a UE 104, an NE 102) may be capable of supporting one or more AI/ML LCM functions, such as data collection, model training, inference, monitoring, and the like. Model training can involve measuring, collecting, logging, and transferring (e.g., transmitting, reporting) data. As an example, an NE 102 may configure multiple UEs 104 to collect and transfer data to the NE 102, and the NE 102 can use the received data to train, re-train, and fine-tune a model. A model may have a higher likelihood of providing a high precision inference outcome if the model is trained with the same conditions, additional conditions, scenarios, and/or configuration that are observed at the time of inference. Thus, collecting data from multiple UEs 104 can improve accuracy and efficiency in model training and implementation. In terms of UE and network behavior, model training may be treated independently from other AI/ML LCM functions, such as inference and monitoring. For example, a model can be trained and readily available at a UE 104 or it can be downloaded from a server, and then applied by the UE 104 for inference if applicable. As another example, performance monitoring of models is performed in close coordination with inference.

In the wireless communications system 100, uplink scheduling may be driven by BSRs transmitted by a UE 104 to an NE 102 or other network node to indicate the amount of uplink data currently buffered at the UE 104. A scheduling request (SR) is a mechanism by which the UE 104 requests uplink resources from the NE 102 when the UE 104 has data to transmit but does not have an available uplink grant. Upon receiving the SR, the NE 102 may allocate uplink resources to the UE 104, and the UE 104 may then transmit a BSR to indicate the amount of data pending in the UE 104's buffer. The NE 102 uses the BSR to determine subsequent uplink resource allocations for the UE 104. In some examples, the UE 104 may also transmit a delay status report (DSR) to indicate delay-related information for data pending in the UE 104's buffer, such as a remaining time until a packet is discarded or a head-of-line delay for buffered data. Additionally, or alternatively, the UE 104 may transmit a power headroom report (PHR) to indicate the difference between the UE 104's maximum transmit power and the power used for a current uplink transmission, which enables the NE 102 to determine how much additional power the UE 104 has available for uplink transmissions.

BSRs may be triggered based on data arrival at the UE's buffer, periodic reporting timers, or other (pre-)configured conditions. For example, when data associated with a logical channel group (LCG) arrives in the UE's buffer and the UE does not have an available uplink grant, the UE may trigger an SR followed by a BSR. The BSR indicates the total amount of data belonging to one or more LCGs, where each LCG may include one or more logical channels (LCs). In some examples, the BSR granularity is at the LCG level, which means the NE may not have visibility into how much data belongs to specific QoS flows or QoS priority classes within an LCG. PHRs may be triggered based on path loss changes, periodic reporting timers, or other (pre-)configured conditions. The reactive nature of conventional BSR and PHR reporting introduces latency in the uplink scheduling process, as the NE only becomes aware of the UE's uplink data and power status after the data has arrived at the UE's buffer and the UE has transmitted the corresponding report.

For advanced services such as immersive communication, XR, and URLLC, QoS demands are increasingly stringent, and the challenge of efficiently distributing uplink resources among multiple UEs in a cell becomes more pronounced. Having advance knowledge of upcoming uplink data traffic at the UE 104 can enhance scheduling decisions at the NE 102, improving system capacity and QoS fulfillment. To this end, traffic prediction may be performed at the UE 104 to forecast uplink data arrivals and provide the NE 102 with predicted uplink status information in advance of the data arriving at the UE 104's buffer. In some examples, AI/ML models may be applied (e.g., implemented, activated) at the UE 104 for traffic prediction. In some other examples, predictions may be generated using non-AI/ML methods such as application layer knowledge (e.g., periodic sensor reporting patterns or periodic XR frame generation), recent packet arrival statistics at the PDCP/RLC layer(s) (e.g., inter-arrival times or burst size distributions), or higher-layer indications from applications or middleware (e.g., explicit announcements of upcoming bursts or changes in QoS). The UE 104 may predict buffer status, delay status, power status, or other uplink-related information for a future time instance based on an inference outcome of a traffic prediction model or based on non-AI/ML methods. The predicted uplink status information may include a predicted data volume, timing information indicating when the data is expected to arrive, a prediction accuracy metric, or other parameters that enable the NE 102 to perform proactive scheduling decisions.

The wireless communications system 100 supports signaling exchanges between the NE 102 and the UE 104 for uplink status reporting as described herein. As used herein, an uplink status of the UE 104 refers to information characterizing the UE 104's uplink traffic conditions, such as the amount of data pending in or expected to arrive at the UE 104's buffer, the delay characteristics of that data, timing information related to expected data, importance of data, QoS of data, data burst information, the UE 104's available transmit power, and the like, among other examples. The uplink status may be reported as a current uplink status based on data currently pending in the buffer of the UE 104, or as a predicted uplink status based on an inference outcome of a traffic prediction model for a future time instance. In other examples, the NE 102 may configure the UE 104 to report both actual and predicted uplink statuses together. Alternatively, the NE 102 may configure the UE 104 to report uplink status information and allow the UE 104 to choose which report type to send.

In some implementations, the NE 102 may transmit a configuration 108 to the UE 104 providing parameters for uplink status reporting. The configuration 108 may be signaled via RRC signaling and may indicate one or more trigger conditions and/or a type of uplink status to be reported (e.g., a current uplink status or a predicted uplink status). Additionally, or alternatively, the configuration 108 may indicate a reporting granularity for the uplink status, such as a logical channel, a logical channel group, a QoS flow, or a QoS priority class. The configuration 108 may, in some cases, indicate one or more parameters to include in the uplink status report 112 and a reporting format for the one or more parameters. In some examples, the NE 102 may configure the UE 104 to report a predicted uplink status for specific traffic types with high QoS priority, such as specific QoS flows or specific QoS priority classes, while other traffic types follow legacy reporting behavior (e.g., conventional BSR reporting).

The one or more trigger conditions indicated by the configuration 108 may include (but are not limited to) an inference outcome being available at the UE 104, a current uplink status deviating from a previously transmitted predicted uplink status, data pending in a buffer of the UE 104 upon expiry of a timer, or data of a priority level exceeding a configured priority threshold pending in the buffer of the UE 104. Additionally, the one or more trigger conditions may include a predicted uplink buffer size for a reporting entity exceeding a configured threshold, detection that upcoming periodic or semi-persistent traffic will not be adequately served by current configured grants (e.g., in terms of size, periodicity, or duration), or a predicted change in delay requirements, such as detection of upcoming low-latency traffic or a change in QoS profile. Additionally, the one or more trigger conditions may include a prediction accuracy criterion, which the UE 104 may consider when determining whether to report the predicted uplink status. In some examples, the configuration 108 may include separate parameters for lower-layer traffic predictions at a MAC layer and higher-layer traffic predictions at an RRC layer, such as filtering coefficients to be applied on lower-layer predictions to derive higher-layer outcomes. The NE 102 may configure the UE 104 with an inference configuration for traffic prediction as part of the configuration 108. The inference configuration may include parameters such as a duration of a prediction window for which the UE 104 should predict the uplink status, filtered traffic types corresponding to high-priority traffic, and a reporting periodicity for the predicted uplink status. The UE 104 may determine an applicability of the inference configuration and report the applicability to the NE 102. In some examples, the UE 104 may report that the inference configuration is applicable or inapplicable based on whether the UE 104 has a suitable model to predict for the inference configuration. The NE 102 may provide a full inference configuration based on the applicability report, and the UE 104 may activate the inference configuration and begin performing inference for traffic prediction.

The one or more trigger conditions indicated by the configuration 108 may include (but are not limited to) an inference outcome being available at the UE 104, a current uplink status deviating from a previously transmitted predicted uplink status, data pending in a buffer of the UE 104 upon expiry of a timer, or data of a priority level exceeding a configured priority threshold pending in the buffer of the UE 104. Additionally, the one or more trigger conditions may include a predicted uplink buffer size for a reporting entity exceeding a configured threshold, detection that upcoming periodic or semi-persistent traffic will not be adequately served by current configured grants (e.g., in terms of size, periodicity, or duration), or a predicted change in delay requirements, such as detection of upcoming low-latency traffic or a change in QoS profile. In some examples, the configuration 108 may include separate parameters for lower-layer traffic predictions at a MAC layer and higher-layer traffic predictions at an RRC layer, such as filtering coefficients to be applied to lower-layer predictions to derive higher-layer outcomes. The NE 102 may configure the UE 104 with an inference configuration for traffic prediction as part of the configuration 108. The inference configuration may include parameters such as a duration of a prediction window for which the UE 104 should predict the uplink status, filtered traffic types corresponding to high-priority traffic, and a reporting periodicity for the predicted uplink status. The UE 104 may determine an applicability of the inference configuration and report the applicability to the NE 102. In some examples, the UE 104 may report that the inference configuration is applicable or inapplicable based on whether the UE 104 has a suitable model to predict for the inference configuration. The NE 102 may provide a full inference configuration based on the applicability report, and the UE 104 may activate the inference configuration and begin performing inference for traffic prediction.

Additionally, or alternatively, the NE 102 may request an uplink status report 112 from the UE 104 via control information 110, which may include a field indicating the request and a type of the requested uplink status (e.g., a current uplink status or a predicted uplink status). In some examples, the NE 102 may signal the control information 110 within DCI, e.g., via PDCCH. In some other examples, the control information 110 may be signaled within a MAC-CE. The field within the control information 110 may further indicate a category of the uplink status to be reported, such as a buffer status, a delay status, a power status, timing information, data burst information, importance information, application-layer metadata, and the like, among other examples. In some examples, the field may comprise a plurality of bits, each bit corresponding to a respective category of the uplink status, enabling the NE 102 to request specific uplink status information that is relevant to the uplink scheduler at a given time. In some cases, the control information 110 may further indicate uplink resources for transmission of the uplink status report 112. Additionally, or alternatively, the NE 102 may use DCI or a MAC-CE to enable or disable reporting of the predicted uplink status, indicate a periodicity or number of reporting instances, indicate a prediction window, or indicate a reference PUSCH format for early PHR computation. In some examples, the DCI may contain a field indicating the reference PUSCH transmission or format to be used for the computation of the predictive early PHR. The field may contain an index of a preconfigured set of PUSCH reference formats identifying the reference PUSCH format to be used for the computation of the predictive PHR. In one example, there may be one index that indicates the UE 104 shall compute and report an early PHR for each reference PUSCH format from the set of reference PUSCH formats.

In response to receiving the configuration 108 and/or the control information 110 (e.g., in response to the request), the UE 104 may transmit an uplink status report 112 to the NE 102. The uplink status report 112 may include information in accordance with the indicated type of the uplink status, which may correspond to a current uplink status based on data currently pending in a buffer of the UE 104 or a predicted uplink status based on an inference outcome of a traffic prediction model implemented by the UE 104. The uplink status report 112 may include one or more of a buffer status, a delay status, a power status, a data volume, timing information indicating when the data is expected to arrive, a prediction accuracy, or information on the importance of the data. In some examples, the uplink status report 112 may include both current uplink status fields and predicted uplink status fields, where the predicted uplink status fields include timing information indicating when the predicted data volume is expected to arrive. A flag field may be included in the uplink status report 112 to distinguish between current and predicted uplink status entries.

In some implementations, the uplink status report 112 for the predicted uplink status may carry at least a predicted buffer status (PBS) and a predicted delay status (PDS). The PBS indicates one or more predicted data amounts per reporting entity for the prediction window. The UE 104 may derive, for each reporting entity, a PBS representing an amount of data expected to arrive during the prediction time window (e.g., in bytes, units, or quantized levels) and/or a PDS describing the delay characteristics of at least a subset of that predicted data. The PDS indicates, for each reporting entity, delay-related descriptors such as latency bounds, urgency levels, or probabilistic latency targets for the predicted data. In some examples, the PDS may include, per reporting entity, a remaining delay status (e.g., time until the packet is being discarded) for a representative packet or group of packets, PDUs, or SDUs. Additionally, or alternatively, the PDS may include a delay bound for one or more delay classes (e.g., ultra-low, low, medium, best-effort), and an indication of how the predicted data amounts map to these delay classes. In another example, the PDS may be encoded using a set of urgency levels and associated time windows, where each urgency level is associated with a quantized target or upper bound on latency within the prediction window. Predicted data volume may then be apportioned across the urgency levels. The NE 102 may receive the uplink status report 112 for the predicted uplink status and pre-allocate uplink grants for one or more future transmission occasions before the corresponding data has reached the UE 104's MAC buffer, thereby reducing head-of-line delay and improving resource utilization.

In some implementations, in parallel with predictive uplink status reporting, the UE 104 maintains its actual buffer status and delay status as traffic arrives and is queued. The UE 104 may generate legacy or actual BSRs indicating current buffered data amount per LCG or other grouping, actual delay status reports indicating current head-of-line delay, queuing delay distribution, or urgency levels for the buffered data, or combined reports that carry both predictive and actual information for the same entities, allowing the NE 102 to directly compare predicted and actual metrics.

In some examples, when a trigger condition is met, the UE 104 forms the uplink status report 112 for the predicted uplink status including one or more PBS fields, each indicating a predicted data amount for a reporting entity over at least part of the prediction horizon, and one or more PDS fields, each associated with a PBS field, indicating delay-related descriptors. The uplink status report 112 for the predicted uplink status may further include optional power-related information, such as predicted power headroom or processing capacity, enabling the scheduler to jointly consider predicted traffic, power constraints, and delay requirements. The uplink status report 112 for the predicted uplink status may reuse or extend existing MAC control element formats or may be defined as a new control element type for predictive status. The association between PBS and PDS fields, and between reporting entities and QoS flows/LCGs, may be signaled via configuration or included via identifiers in the uplink status report 112.

The configuration 108 for uplink status reporting may extend the conventional BSR configuration. Conventionally, the following parameters may be configured to control BSR reporting: a periodic BSR timer (periodicBSR-Timer), a retransmission BSR timer (retxBSR-Timer), a logical channel SR delay timer applied indicator (logicalChannelSR-DelayTimerApplied), a logical channel SR delay timer (logicalChannelSR-DelayTimer), a logical channel SR mask (logicalChannelSR-Mask), a logical channel group identifier (logicalChannelGroup), a small data transmission logical channel SR delay timer (sdt-LogicalChannelSR-DelayTimer), and an additional buffer size table allowed indicator (additionalBS-TableAllowed). The configuration 108 may extend these conventional parameters with additional parameters for controlling reporting of the predicted uplink status, as described below.

Upon receiving the uplink status report 112 for the predicted uplink status, the NE 102 may compute uplink resource allocations for one or more future transmission occasions within the prediction window, before the corresponding data has reached the UE 104's MAC buffer. The NE 102 may allocate grant sizes per future uplink time interval based on the PBS, prioritizing entities with more stringent PDS (e.g., lower latency bounds or higher urgency) while considering other UEs' demands. Additionally, or alternatively, the NE 102 may adapt modulation and coding scheme (MCS), repetition, and HARQ configuration based on predicted traffic, channel state information, and UE power information. In some examples, the NE 102 may reserve resources across multiple cells, carriers, or RATs for predicted traffic, especially in multi-connectivity scenarios where different paths can be leveraged. For instance, for an XR application with predictable frame generation times and delay constraints, the uplink status report 112 for the predicted uplink status with PBS and PDS enables the scheduler to allocate uplink resources just in time to avoid head-of-line delay without over-provisioning.

The NE 102 may receive the uplink status report 112 and use the information to perform scheduling decisions and resource allocation for uplink transmissions from the UE 104. In some examples, the NE 102 may pre-allocate uplink resources for one or more future transmission occasions within a prediction window indicated by the uplink status report 112 for the predicted uplink status. In some implementations, if the reporting granularity is limited to the LCG level, the NE 102 may configure the UE 104 such that high-priority QoS flows are mapped to the same LCG and not combined with low-priority or other QoS flows. This mapping may ensure that the NE 102 can distinguish high-priority traffic from other traffic within the uplink status report 112 even when reporting is performed at the LCG level.

In some examples, the configuration 108 may include specific parameters for controlling reporting of the predicted uplink status. For example, the configuration 108 may include a parameter indicating whether reporting of the predicted uplink status is enabled or disabled (e.g., a predictiveTrafficStatus parameter). The configuration 108 may further include parameters for lower-layer traffic prediction information (e.g., a predictiveLowLayerTrafficInfo parameter for traffic predictions at the MAC layer) and higher-layer traffic prediction information (e.g., a predictiveHighLayerTrafficInfo parameter for traffic predictions at the RRC layer). In some examples, the configuration 108 may include detailed parameters to control the reporting of the predicted uplink status, such as a periodic predicted BSR timer, a retransmission predicted BSR timer, a logical channel predicted SR delay timer, a logical channel predicted SR mask, or a reporting quantity indicating which uplink status characteristics to include in the uplink status report 112 (e.g., volume, type, delay). In some other examples, the NE 102 may only configure whether the UE 104 can report predicted uplink status values, and the remaining parameters for reporting the predicted uplink status may follow the same parameter settings as conventional BSR reporting or may be left to UE implementation.

In some implementations, the NE 102 may configure the UE 104 to apply either traffic prediction-based uplink status reporting or pre-emptive BSR reporting. Legacy BSR reporting may remain mandatory and may be further fine-tuned or adapted based on the traffic prediction-based uplink status reporting. In some examples, the NE 102 may configure the UE 104 with multiple reporting measures (e.g., predicted uplink status, current uplink status, pre-emptive BSR), and the UE 104 may report all configured measures independently of one another.

In some implementations, the uplink status report 112 may include information on the importance of the data being predicted to arrive in the buffer of the UE 104. Different data may contribute differently to an application or to user perception. For instance, the UE 104 may notify the NE 102 of high-importance data, such as data that contributes significantly to the user's perceived experience (e.g., high-importance tokens), which is predicted to arrive in a configured prediction window. This importance information may enable the NE 102 to prioritize scheduling for data that has a greater impact on user experience. In some implementations, the NE 102 may allocate dedicated uplink resources for the UE 104 that are designated for transmission of the uplink status report 112. The UE 104 may transmit the uplink status report 112 along with the highest QoS priority data available in the buffer of the UE 104 on the dedicated uplink resources. That is, the dedicated uplink resources may be used to carry both the uplink status report 112 and the high-priority data itself, reducing the number of signaling exchanges needed before the UE 104 can begin transmitting data.

In some implementations, the uplink status report 112 may include power status information based on a reference uplink allocation. A reference uplink allocation refers to a preconfigured uplink transmission format that the UE 104 uses as a basis for computing power headroom when no actual uplink transmission is scheduled. Because power headroom is computed as the difference between the UE's maximum transmit power and the power used for an uplink transmission, and because no actual uplink transmission may be occurring at the time the UE 104 generates the uplink status report 112 for the predicted uplink status, the UE 104 may use a reference uplink allocation to compute the power headroom. The reference uplink allocation may include a reference PUSCH format, which specifies parameters such as a number of resource blocks, a modulation and coding scheme, or other transmission parameters that define a hypothetical PUSCH transmission for the purpose of the power headroom computation. The reference PUSCH format may be configured by the NE 102 based on expected PUSCH allocations for a given service, such as bursty traffic associated with immersive services, where the NE 102 has some knowledge of the expected transport block size for a data burst. The UE 104 may compute a power headroom value for the reference PUSCH format using an MPR value determined by the UE 104 for the reference PUSCH format, rather than assuming no power back-off as in conventional virtual PHR computations. This early PHR information enables the NE 102 to adapt its scheduling strategy and provide efficient uplink scheduling at the beginning of a data burst.

For example, the UE 104 may compute the power headroom value for the reference PUSCH format based on a power headroom computation formula, such as the difference between a configured maximum output power and a computed PUSCH transmission power. The computed PUSCH transmission power may include a power offset parameter, a path loss compensation term, and a power control adjustment state. In contrast to conventional virtual PHR computations where the UE assumes no power back-off (e.g., MPR=0 dB, A-MPR=0 dB, P-MPR=0 dB) and a PUSCH allocation of one resource block, the UE 104 may determine the MPR value, the A-MPR value, and the P-MPR value for the reference PUSCH format based on the actual power back-off conditions. Additionally, or alternatively, the UE 104 may determine a pathloss reference for the reference PUSCH format based on a pathloss reference determined by the UE 104, rather than using a default pathloss reference.

In some examples, the UE 104 may skip transmitting the uplink status report 112 for the current uplink status when the NE 102 has already received the uplink status report 112 for the predicted uplink status and has allocated uplink resources based on that prediction. Because the NE 102 has already been informed of the expected traffic and has granted resources accordingly, there may be no need for the UE 104 to send a separate uplink status report 112 for the same data. In some examples, the UE 104 may also skip transmitting the uplink status report 112 for the current uplink status when the actual data that arrives in the buffer matches what was previously predicted for the same reporting granularity (e.g., the same logical channel, LCG, or QoS class). Additionally, or alternatively, the UE 104 may cancel the uplink status report 112 for the current uplink status if the UE 104 has received a dynamic grant or configured grant that is sufficient for the predicted data volume.

In some implementations, trigger conditions for the uplink status report 112 may be tied to actual resource utilization. The earlier the UE 104 can notify the NE 102 about over-allocations (e.g., unused uplink resources allocated to the UE 104), the more likely it is that the NE 102 can reallocate those resources to other users. For example, the UE 104 may predict the usage of allocated uplink resources based on the predicted uplink status information. If over-allocation is frequently observed, the UE 104 may transmit a new uplink status report 112 for the predicted uplink status with lowered predicted buffer amounts and an explicit indication of under-utilization. If under-allocation is frequently observed, the UE 104 may transmit an uplink status report 112 for the predicted uplink status with increased predicted traffic or more stringent delay status values to cause the NE 102 to allocate larger or more frequent grants. This resource-utilization-based feedback mechanism may stabilize prediction-driven scheduling.

In some examples, performance monitoring of traffic predictions may be initiated and maintained by the NE 102 or by the UE 104. In NE-initiated performance monitoring, the NE 102 may configure the UE 104 with a performance monitoring configuration that includes parameters such as performance measures to report, accuracy of prediction, ground truth values, or predicted values. The NE 102 may conduct performance monitoring based on the uplink status reports 112 for the predicted uplink status and the uplink status reports 112 for the current uplink status received from the UE 104, and may reconfigure or deconfigure the UE 104 with inference-related configuration based on the outcome of performance monitoring. For instance, the NE 102 may perform explicit monitoring of prediction performance by transmitting the control information 110 to request one-shot uplink status reports 112 for the current uplink status at specified times or uplink opportunities. The NE 102 may compare the received uplink status reports 112 for the current uplink status with stored uplink status reports 112 for the predicted uplink status for the corresponding prediction interval to compute prediction performance indicators, and may adapt the configuration 108 or disable reporting of the predicted uplink status based on the prediction accuracy.

In UE-initiated performance monitoring, the UE 104 may initiate the performance monitoring and perform management decisions regarding whether to continue performing inference. The UE 104 may indicate its final outcome, such as a decision for inference or a final performance monitoring outcome, to the NE 102. For instance, the UE 104 may monitor the performance of its own traffic predictions by periodically evaluating their accuracy. The UE 104 may compute a prediction error metric based on a comparison of the predicted uplink status with the current uplink status. If the prediction error metric exceeds a configured threshold, the UE 104 may transmit a correction uplink status report to update the NE 102 with the current uplink status. The correction uplink status report may include one or more of an updated actual buffer status, updated actual delay status, revised predictions for the remainder of the prediction horizon, or an indication that previous allocations based on the predicted uplink status should be adjusted, reduced, extended, or invalidated.

In some implementations, performance monitoring of traffic predictions may include a third option in addition to NE-initiated and UE-initiated performance monitoring. In NE-initiated, UE-decision performance monitoring, the UE 104 may be configured to perform performance monitoring based on the configuration 108 from the NE 102. However, the decision related to AI/ML inference based on the measured performance may depend on UE implementation. For example, the UE 104 may pause or stop performing inference and reporting the predicted uplink status if the performance is below the expected performance measures, without requiring a management decision from the NE 102.

In some implementations, the UE 104 may be configured for multi-connectivity or split-bearer operation, wherein the UE 104 maintains multiple uplink paths via different cells, carriers, or RATs. The uplink status report 112 may include predictive buffer and delay information per link, cell group, or MAC entity. In some examples, the UE 104 may predict not only total uplink traffic but also a distribution of that traffic across multiple links, taking into account predicted link conditions such as SINR, load, or scheduling constraints. The NE 102 may use this information to pre-allocate resources on the different links in a way that meets the predicted delay requirements while balancing load and exploiting favorable channel conditions. In some examples, the uplink status report 112 may include UE suggestions for splitting uplink traffic among cell groups, determined based on predicted channel conditions and delay constraints for each path. The NE 102 may follow or override these suggestions based on scheduling policies.

In some implementations, traffic prediction may be performed at different protocol layers within the UE 104. In some examples, a lower-layer traffic prediction module operating at a MAC layer may receive data arrival statistics and traffic assistance information as inputs and generate prediction outcomes for one or more time instances. The prediction outcomes may be provided to a higher-layer traffic prediction module operating at an RRC layer, which may produce a final prediction or computation outcome. In some other examples, a lower-layer traffic module may collect and forward traffic statistics over a long period to a higher-layer traffic prediction module, which may then perform the prediction and produce the prediction or computation outcome. The higher-layer traffic prediction module may apply filtering or averaging operations to the lower-layer predictions or statistics to derive longer-term traffic characteristics.

In some implementations, for UE-side traffic prediction models, it may be left to UE implementation to train the models and collect the respective data for training related to traffic predictions. The UE 104 may log available relevant information related to data traffic, such as data arrival rate, scheduling requests, buffer status reports, type of traffic, application type, or scheduling information received from the NE 102. The transfer of data to any external UE server may be performed using a general data transfer applied for other AI/ML applications. Additionally, or alternatively, the inference may be performed by an entity at the network side. For this purpose, the NE 102 may configure the UE 104 to log traffic-related measures over time (e.g., traffic volume, timing information, delay information, application type), which may be transferred to the NE 102 as per a reporting configuration for the logged data. In some other examples, the NE 102 may use the uplink status reports 112 for the current uplink status received from the UE 104, such as scheduling requests and buffer status reports, to train its models for traffic prediction.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

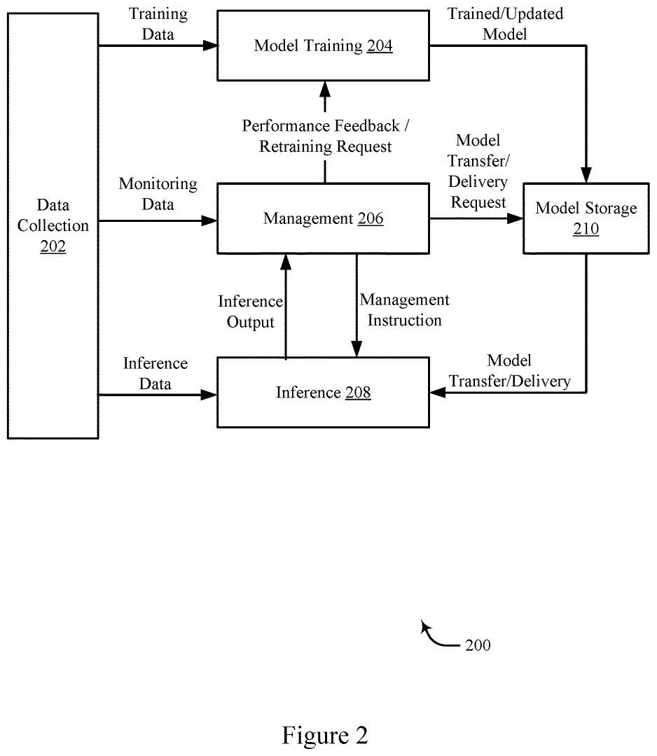

FIG. 2 illustrates an example of an AI/ML functional framework 200. In some examples, the AI/ML functional framework 200 implements or is implemented by aspects of the wireless communications system 100. For example, the AI/ML functional framework 200 can implement aspects of, or can be implemented by, a UE and/or a NE, which may be examples of a UE 104 and a NE 102 as described with reference to FIG. 1.

The AI/ML functional framework 200 includes a set of functionalities (e.g., AI/ML functionalities) implemented to operate and manage one or more learning models as described herein. The set of functionalities includes a data collection function 202, a model training function 204, a management function 206, an inference function 208, and a model storage function 210. It is to be understood that the examples described herein are for the purposes of illustration and are not to be construed as limiting. For example, the AI/ML functional framework 200 may include any quantity and combination of functionalities including functionalities not discussed herein.

The data collection function 202 can provide input data to the model training function 204, the management function 206, and the inference function 208. For example, the data collection function 202 provides training data as input for the model training function, monitoring data as input for the management function, and inference data as input for the inference function. The model training function 204 can perform model training, validation, and testing, and generates model performance metrics for use as part of model testing procedures. The model training function 204 is also responsible for data preparation (e.g., data preprocessing and cleaning, formatting, and transformation) based on the training data (e.g., as delivered by the data collection function).

Broadly, the management function 206 oversees the operation (e.g., selection, activation, deactivation, switching, fallback) and monitoring (e.g., performance monitoring) of models and/or functionalities. The management function 206 is further responsible for making decisions that ensure proper inference operation based on data received from the inference function 208 and the data collection function 202. For example, based on received data, the management function 206 can provide information, such as management instructions, as input to the inference function 208. Management instructions may include, but are not limited to, selection, activation, deactivation, and switching of models and/or functionalities, fallback to non-AI/ML operations (e.g., no longer relying on inference processes), and the like. The management function 206 may input model transfer and/or delivery requests to the model storage function 210 to request model(s) from the model storage function 210. Additionally, or alternatively, the management function 206 can input performance feedback and/or retraining requests to the model training function 204, e.g., for model training, re-training, or updating purposes.

The inference function 208 provides outputs obtained from the process of applying models and/or functionalities using the data input by the data collection function 202 (also referred to herein as inference data). The inference function 208 is further responsible for data preparation (e.g., data preprocessing and cleaning, formatting, and transformation) based on inference data delivered by the data collection function 202. Inference output refers to data provided by the inference function 208 to the management function 206 for monitoring the performance of models and/or functionalities. The model storage function 210 stores trained and updated models that can be used to perform the inference function 208.

LCM of models and functionalities (e.g., AI/ML models and functionalities) can include model-ID-based LCM and functionality-based LCM. As described herein, “functionality” refers to an AI/ML-enabled feature/FG enabled by one or more configurations that are, in turn, supported based on conditions indicated by UE capabilities. Thus, functionality-based LCM operates based on at least one configuration of an AI/ML-enabled feature or feature group. In functionality-based LCM, the network (e.g., an NE) indicates (e.g., to one or more other network nodes, such as UEs and/or NEs) selection, activation, deactivation, fallback, and switching of functionalities via 3GPP signaling (e.g., RRC, MAC-CE, DCI). Models may not be identified at the network, and UEs may perform model-level LCM. A UE may have one or more models for a functionality. Functionality identification may be achieved by defining one or more functionalities within an AI/ML-enabled feature (e.g., a feature where AI/ML may be used). Whether and how much awareness and/or interaction the network should have about model-level LCM at a UE may require further study. Additionally, mechanisms and parameters for UE reporting of updates on applicable functionalities, where applicable functionalities include a subset of all functionalities, may be studied.

In model-ID-based LCM, models are identified at the network, and the network and/or a UE may activate, deactivate, select, and switch individual models via model IDs. Model-ID-based LCM operates based on identified models, where a model may be associated with particular configurations and/or conditions associated with UE capability of an AI/ML-enabled feature/FG, and with additional conditions (e.g., scenarios, sites, datasets) as determined or identified between the UE and the network. A model may be assigned a model ID during model identification, which may be communicated between nodes. A model ID can be used within functionalities and for different data/information/instruction flows to identify an AI/ML model. For example, a model ID may be associated with selection/(de)activation/switching of a model or linked to model transfer/delivery information associated with the model.

Additionally, once a model is identified, a UE may indicate model IDs for a given functionality or feature, e.g., as part of UE capability reporting. A model ID may or may not be globally unique, and different types of model IDs may be created for a single model for different LCM purposes. Once a functionality and/or a model is identified, the same or similar procedures may be used for activation, deactivation, switching, fallback, and monitoring. In some examples, a model ID can be used in a functionality for LCM operations. Further study may be useful regarding handling the impact of UE internal conditions (e.g., memory, battery, and other hardware limitations) on functionality and/or model operations and AI/ML-enabled features.

The AI/ML functional framework 200 enables application of AI/ML features and functionalities at a node (e.g., a UE, an NE). As part of UE capability and UE assistance information (UAI) procedures, a UE indicates AI/ML functionalities/use-cases/sub-use-cases (e.g., temporal beam management, traffic prediction, etc.) that it supports for inference. This UE capability information may be signaled autonomously by the UE and/or in response to reception of a capability request transmitted by the network (e.g., an NE).

For an AI/ML-enabled feature or feature group (FG), additional conditions refer to aspects assumed for training of a model but not part of UE capability for the AI/ML-enabled feature or FG. Additional conditions may be divided into network-side (NW-side) additional conditions and UE-side additional conditions. For inference for UE-side models, to ensure consistency between training and inference regarding NW-side additional conditions (if identified), the following approaches may be taken as potential options (when feasible and necessary): model identification to achieve alignment on the NW-side additional condition between NW-side and UE-side; model training at the network and transfer to the UE, where the model has been trained under the additional condition; information and/or indication on NW-side additional conditions provided to the UE; and consistency assisted by monitoring (by the UE and/or the network) of the performance of UE-side candidate models or functionalities to select a model or functionality. Other approaches are not precluded.

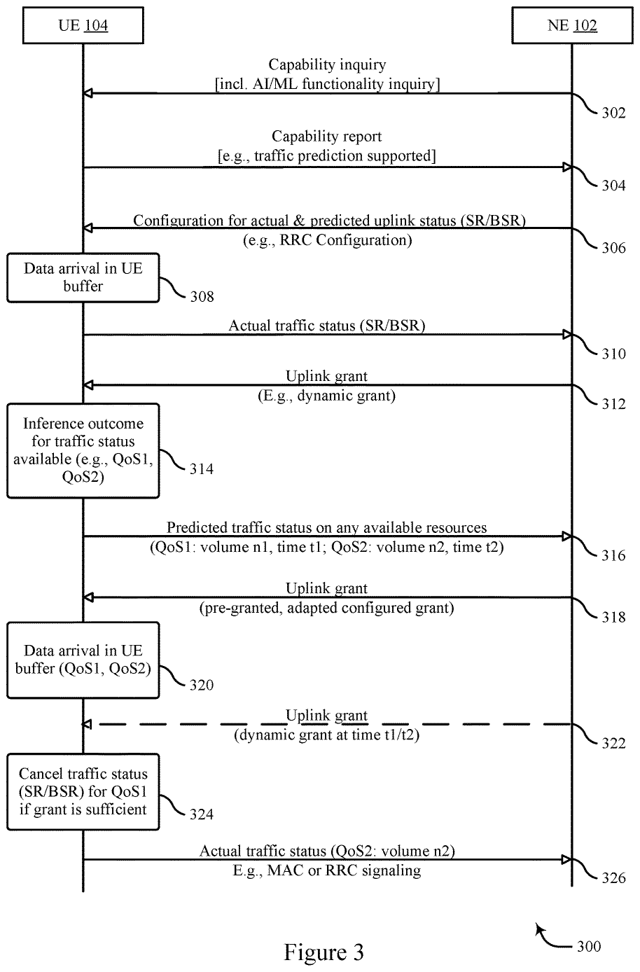

FIG. 3 illustrates an example signaling diagram 300 in accordance with aspects of the present disclosure. In some examples, the signaling diagram 300 implements or is implemented by aspects of the wireless communications system 100. For example, operations of the signaling diagram 300 may be implemented by a UE 104 and an NE 102 as described with reference to FIG. 1. The signaling diagram 300 illustrates how the NE 102 and the UE 104 may coordinate to configure and report both actual and predicted traffic status information for uplink scheduling. The examples described herein are not to be construed as limiting. For example, any network node may perform the operations of the signaling diagram 300.

At 302, the NE 102 may transmit a capability inquiry to the UE 104. The capability inquiry may include an AI/ML functionality inquiry to determine the AI/ML functionalities supported by the UE 104. In some examples, the capability inquiry may request information regarding whether the UE 104 supports traffic prediction for uplink status reporting.

At 304, the UE 104 may transmit a capability report to the NE 102, e.g., in response to the capability inquiry. The capability report may indicate one or more AI/ML functionalities supported by the UE 104, including traffic prediction for uplink status reporting. The capability report enables the NE 102 to determine whether the UE 104 can be configured for predictive uplink status reporting in addition to legacy reporting (e.g., reporting of the current uplink status).

At 306, based on the capability report, the NE 102 may transmit a configuration 108 to the UE 104, e.g., via RRC signaling. The configuration 108 may provide parameters for uplink status reporting, including parameters for reporting the current uplink status and the predicted uplink status. In some examples, the configuration 108 may include parameters for SR and BSR procedures. The configuration 108 may indicate one or more trigger conditions and a type of uplink status to be reported (e.g., a current uplink status or a predicted uplink status). Additionally, or alternatively, the configuration 108 may indicate a reporting granularity for the uplink status, such as a logical channel, a logical channel group, a QoS flow, or a QoS priority class. For example, the NE 102 may not be interested in predicted uplink status reporting for all types of traffic at the UE 104. To this end, the configuration 108 may indicate allowed logical channels, QoS classes, or QoS flows for which the UE 104 should perform predictions. Accordingly, the configuration 108 may enable the UE 104 to provide a predicted uplink status for logical channels or specific traffic types with higher priority based on traffic QoS requirements, such as latency, while other traffic types may follow legacy reporting behavior.

In some examples, the configuration 108 at 306 may include an indication of whether SR-free reporting is enabled. When SR-free reporting is enabled, the UE 104 may report the predicted uplink status without first transmitting an SR. Because the sequential SR-BSR design introduces a delay until the uplink grant is received, and TDD formats may further restrict the transmission of the SR over PUCCH to uplink slots, allowing the UE 104 to bypass the SR for the predicted uplink status may reduce latency for high-priority traffic. In some examples, a default lowest SR opportunity (e.g., sub-millisecond based on PeriodicityAndOffset configuration in PUCCH) may be allocated or configured for traffic status of specific logical channels or QoS classes, or for predicted traffic status in general. In some examples, the UE 104 may bypass the SR by directly triggering the uplink status report 112 on dedicated uplink resources or by using other available grants (e.g., PUSCH resources). Additionally, or alternatively, the NE 102 may allocate dedicated uplink resources for the UE 104 that are sufficient for transmission of the uplink status report 112 for the current uplink status or the predicted uplink status. The dedicated uplink resources may allow the UE 104 to transmit the uplink status report 112 without the additional step of SR transmission and waiting for an initial uplink grant. Because the UE 104 is expected to be predicting upcoming traffic for one or more high-priority QoS flows, the UE 104 may transmit the uplink status report 112 for the predicted uplink status in advance on the dedicated uplink resources even if the high-priority data is not yet present in the buffer of the UE 104 at the time of reporting. Logical channels, LCGs, or QoS flows not configured by the NE 102 as high-priority may follow the traditional SR-BSR-uplink grant process to initiate transmission.

At 308, data arrival may occur in a buffer of the UE 104. The data arrival may correspond to uplink data associated with one or more logical channels or QoS flows.

At 310, in response to the data arrival, the UE 104 may transmit the uplink status report 112 for the current uplink status to the NE 102. The uplink status report 112 for the current uplink status may include an SR or a BSR indicating the amount of data currently pending in the buffer of the UE 104. The uplink status report 112 for the current uplink status may be triggered based on the data arrival at the buffer of the UE 104 in accordance with the configuration 108 received at 306. The uplink status report 112 for the current uplink status at 310 represents the conventional reactive reporting behavior, where the UE 104 informs the NE 102 of data that has already arrived.

At 312, the NE 102 may transmit an uplink grant to the UE 104 based on the uplink status report 112 for the current uplink status received at 310. The uplink grant may be a dynamic grant that allocates uplink resources for the UE 104 to transmit the data pending in the buffer.

At 314, an inference outcome for traffic prediction may become available at the UE 104. The inference outcome may correspond to a predicted uplink status for one or more QoS classes, such as a first QoS class (QoS1) and a second QoS class (QoS2). In some examples, the inference outcome may be generated by a traffic prediction model operating at the UE 104. The traffic prediction function may use one or more information sources to generate the prediction. For example, the traffic prediction model may use application layer knowledge, such as periodic sensor reporting patterns or periodic XR frame generation. Additionally, or alternatively, the traffic prediction model may use recent packet arrival statistics at PDCP/RLC, such as inter-arrival times or burst size distributions. Additionally, or alternatively, the traffic prediction model may use higher-layer indications from applications or middleware, such as explicit announcements of upcoming bursts or changes in QoS. Additionally, or alternatively, the traffic prediction model may use AI/ML models trained locally or externally to forecast uplink data arrivals and delay constraints based on historical traffic, user context, and application profiles. In some examples, the UE 104 may already be performing such predictions based on UE implementation, and the techniques described herein provide a standardized framework for integrating these predictions into the uplink scheduling procedure.

At 316, the UE 104 may transmit the uplink status report 112 for the predicted uplink status to the NE 102 on any available resources. The uplink status report 112 for the predicted uplink status may include volume and timing information for each QoS class. For example, the uplink status report 112 for the predicted uplink status may indicate a volume n1 expected at time t1 for QoS1 and a volume n2 expected at time t2 for QoS2. In some examples, the uplink status report 112 for the predicted uplink status may further include a prediction accuracy metric. The uplink status report 112 for the predicted uplink status may be triggered based on the inference outcome being available at the UE 104 in accordance with the one or more trigger conditions indicated by the configuration 108 received at 306. In some examples, the uplink status report 112 for the predicted uplink status may be triggered if the inference outcome is available and a prediction accuracy criterion is met. The prediction accuracy criterion may be preconfigured by the NE 102 or may be based on UE implementation. For the predicted uplink status, it may be desirable to configure or otherwise enable the UE 104 to trigger the uplink status report 112 as soon as the inference outcome is available, e.g., without following a periodic reporting pattern. In some examples, the UE 104 may bypass the SR for the predicted uplink status by directly triggering the uplink status report 112 on dedicated uplink resources or by using other available grants (e.g., PUSCH resources).

At 318, the NE 102 may transmit an uplink grant to the UE 104 based on the uplink status report 112 for the predicted uplink status received at 316. The uplink grant may be a pre-granted or adapted configured grant based on the predicted information. In some examples, the NE 102 may adjust configured grant patterns (e.g., grant size, repetition, and periodicity) to match predicted uplink flows. The NE 102 may pre-allocate uplink resources for one or more future transmission occasions within a prediction window indicated by the uplink status report 112 for the predicted uplink status. By pre-allocating resources before the corresponding data has arrived at the buffer of the UE 104, the NE 102 may reduce head-of-line delay and improve resource utilization.

At 320, data arrival may occur in the buffer of the UE 104 for QoS1 and QoS2, corresponding to the previously predicted traffic.

At 322, the NE 102 may transmit an uplink grant to the UE 104 as a dynamic grant at time t1 or t2 corresponding to the predicted arrival times indicated in the uplink status report 112 for the predicted uplink status at 316. The dynamic grant at 322 may be in addition to or in place of the pre-granted or configured grant at 318, depending on the scheduling decisions of the NE 102.

At 324, the UE 104 may cancel the uplink status report 112 for the current uplink status (e.g., cancel the SR or BSR) for QoS1. The UE 104 may cancel the uplink status report 112 for the current uplink status if the grant received at 318 or 322 is sufficient for the predicted data volume for QoS1. More generally, the UE 104 may refrain from transmitting the uplink status report 112 for the current uplink status based on a prior transmission of the uplink status report 112 for the predicted uplink status and receipt of an uplink grant based on the predicted uplink status. In some examples, the UE 104 may refrain from transmitting the uplink status report 112 for the current uplink status when the current uplink status is not different from the previously reported predicted uplink status for a same reporting granularity. Because the NE 102 has already allocated resources based on the prediction, there may be no need for the UE 104 to request those same resources again with a traditional BSR. This cancellation mechanism may reduce signaling overhead by avoiding redundant reporting.

At 326, the UE 104 may transmit the uplink status report 112 for the current uplink status to the NE 102 for QoS2 with volume n2. The uplink status report 112 for the current uplink status may be transmitted via MAC or RRC signaling. In some examples, the UE 104 may transmit the uplink status report 112 for the current uplink status for QoS2 because the uplink grant received was not sufficient for the predicted data volume for QoS2, or because the current uplink status for QoS2 differs from the previously reported predicted uplink status. Not all types of legacy reporting may be cancelled, particularly when the uplink grant was not sufficient for different QoS classes or when data remains pending in the buffer. In some examples, the uplink status report 112 for the current uplink status at 326 may serve as a correction to the uplink status report 112 for the predicted uplink status, enabling the NE 102 to update its scheduling view and allocate additional uplink resources as needed.

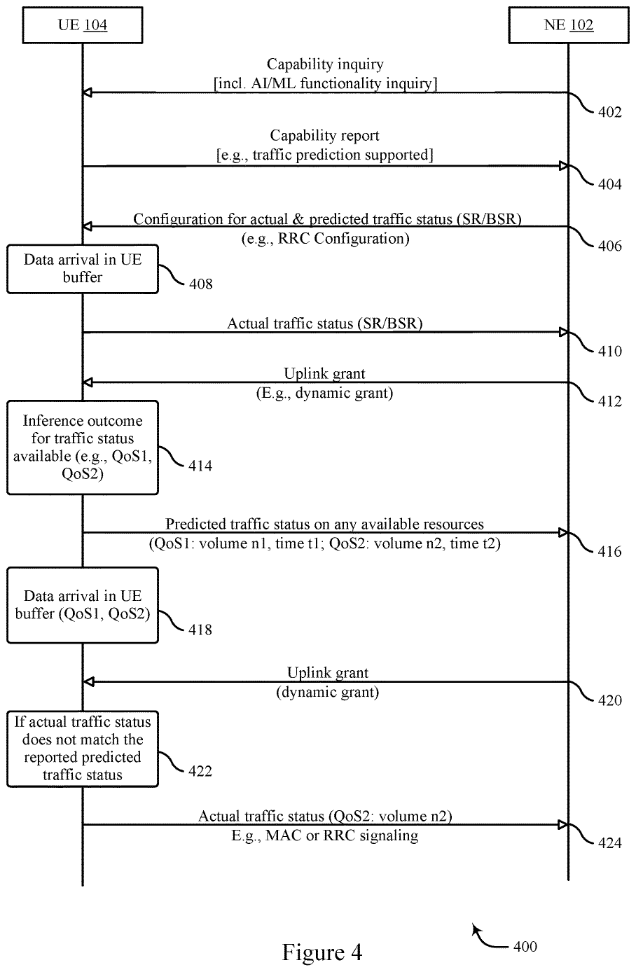

FIG. 4 illustrates an example signaling diagram 400 in accordance with aspects of the present disclosure. In some examples, the signaling diagram 400 implements or is implemented by aspects of the wireless communications system 100. For example, operations of the signaling diagram 400 may be implemented by a UE 104 and an NE 102 as described with reference to FIG. 1. The signaling diagram 400 illustrates how the NE 102 and the UE 104 may coordinate to report predicted and actual traffic status information, where the UE 104 transmits an actual traffic status when the actual traffic status does not match a previously reported predicted traffic status. The examples described herein are not to be construed as limiting. For example, any network node may perform the operations of the signaling diagram 400.

At 402, the NE 102 may transmit a capability inquiry to the UE 104. The capability inquiry may include an AI/ML functionality inquiry. In some examples, the capability inquiry may request information regarding whether the UE 104 supports traffic prediction for uplink status reporting.

At 404, the UE 104 may transmit a capability report to the NE 102 in response to the capability inquiry. The capability report may indicate that the UE 104 supports traffic prediction.

At 406, based on the capability report, the NE 102 may transmit a configuration 108 to the UE 104 for uplink status reporting, including parameters for reporting the current uplink status and the predicted uplink status. The configuration 108 may be provided via RRC signaling. The configuration 108 may indicate one or more trigger conditions and a type of uplink status to be reported (e.g., a current uplink status or a predicted uplink status). In some examples, the configuration 108 may include parameters for SR and BSR procedures.

At 408, data arrival may occur in a buffer of the UE 104. The data arrival may correspond to uplink data associated with one or more logical channels and/or QoS flows.

At 410, in response to the data arrival, the UE 104 may transmit the uplink status report 112 for the current uplink status to the NE 102. The uplink status report 112 for the current uplink status may include an SR or a BSR indicating the amount of data currently pending in the buffer of the UE 104.

At 412, the NE 102 may transmit an uplink grant to the UE 104 based on the uplink status report 112 for the current uplink status received at 410. The uplink grant may be a dynamic grant that allocates uplink resources for the UE 104 to transmit the data pending in the buffer.

At 414, an inference outcome for traffic prediction may become available at the UE 104. The inference outcome may correspond to a predicted uplink status for one or more QoS classes, such as QoS1 and QoS2. In some examples, the inference outcome may be generated by a traffic prediction model operating at the UE 104.

At 416, the UE 104 may transmit the uplink status report 112 for the predicted uplink status to the NE 102 on any available resources. The uplink status report 112 for the predicted uplink status may include volume and timing information for each QoS class, such as a volume n1 expected at time t1 for QoS1 and a volume n2 expected at time t2 for QoS2. The uplink status report 112 for the predicted uplink status may be triggered based on the inference outcome being available at the UE 104, e.g., in accordance with the one or more trigger conditions indicated by the configuration 108 received at 406.

At 418, data arrival may occur in the buffer of the UE 104 for QoS1 and QoS2, corresponding to the previously predicted traffic.

At 420, the NE 102 may transmit an uplink grant to the UE 104. The uplink grant may be a dynamic grant based on the previously reported uplink status report 112 for the predicted uplink status, e.g., at 416. That is, the uplink grant may indicate resources for the UE 104 to use for the predicted traffic.

At 422, the UE 104 may determine whether the current uplink status matches the previously-reported predicted uplink status. For example, the UE 104 may compare the actual data volume or timing for one or more QoS classes with the corresponding predicted values reported in the uplink status report 112 at 416. To perform this comparison, the UE 104 may compute a prediction error metric. The UE 104 stores, for each prediction time window or report instance, the predicted uplink status information (e.g., PBS and PDS values that were transmitted). As actual data arrivals and delays are observed, the UE 104 computes one or more prediction error metrics. The prediction error metric may include an absolute difference in bytes between the predicted and actual buffer level, a relative error in the predicted buffer level (e.g., a percentage deviation), a difference between predicted and actual delay metrics or classes, or an aggregated error over multiple time windows or reporting intervals. If the prediction error metric exceeds a configured threshold, the UE 104 may determine that the current uplink status does not match the previously-reported predicted uplink status. The configured threshold may be provided by the NE 102 as part of the configuration 108 at 406, or may be based on UE implementation.

At 424, based on a determination at 422 that the current uplink status does not match the previously reported predicted uplink status, the UE 104 may transmit the uplink status report 112 for the current uplink status to the NE 102. The uplink status report 112 for the current uplink status may be transmitted via MAC or RRC signaling and may include volume information for the relevant QoS class, such as the actual volume for QoS2. In some examples, the uplink status report 112 for the current uplink status at 424 may serve as a correction uplink status report that updates the NE 102 with the current uplink status. In some examples, the correction uplink status report may include an updated actual buffer status, an updated actual delay status, revised predictions for the remainder of the prediction horizon, or an indication that previous allocations based on the uplink status report 112 for the predicted uplink status at 416 should be adjusted. Upon receiving the correction uplink status report, the NE 102 may update its scheduling view accordingly. For example, the NE 102 may reduce or increase future uplink grants, adjust configured grants, or update internal prediction quality metrics for the UE 104. If prediction accuracy remains poor over time, the NE 102 may reconfigure shorter prediction horizons, different trigger conditions, or disable predictive uplink status reporting for the UE 104.

The signaling diagram 400 illustrates a trigger condition in which the UE 104 transmits the uplink status report 112 for the current uplink status when the current uplink status deviates from the previously transmitted predicted uplink status. In contrast to the signaling diagram 300 described with reference to FIG. 3, where the UE 104 may cancel the uplink status report 112 for the current uplink status when the prediction is accurate and the grant is sufficient, the signaling diagram 400 illustrates a scenario in which the UE 104 detects a mismatch between the predicted uplink status and the current uplink status and proactively reports the current uplink status. This proactive correction enables the NE 102 to maintain an accurate view of the UE 104's uplink status even when predictions are not fully accurate. The NE 102 may then adapt its resource allocation in response to the updated information, rather than continuing to schedule based on outdated predictions.

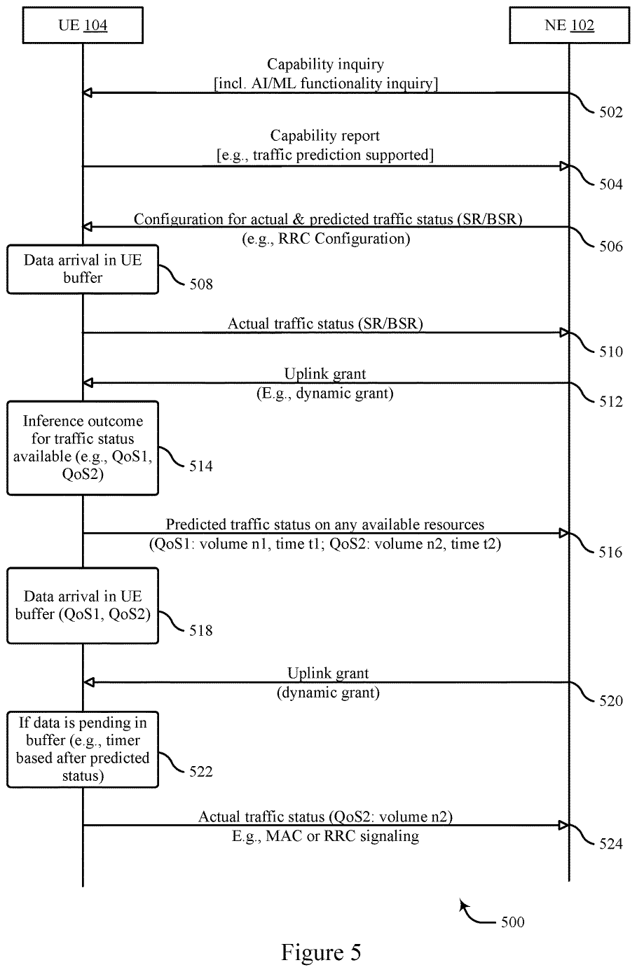

FIG. 5 illustrates an example signaling diagram 500 in accordance with aspects of the present disclosure. In some examples, the signaling diagram 500 implements or is implemented by aspects of the wireless communications system 100. For example, operations of the signaling diagram 500 may be implemented by a UE 104 and an NE 102 as described with reference to FIG. 1. The signaling diagram 500 illustrates how the NE 102 and the UE 104 may coordinate to report predicted and actual traffic status information, where the UE 104 determines whether to transmit an actual traffic status based on data pending in a buffer of the UE 104 upon expiry of a timer. The examples described herein are not to be construed as limiting. For example, any network node may perform the operations of the signaling diagram 500.

At 502, the NE 102 may transmit a capability inquiry to the UE 104. The capability inquiry may include an AI/ML functionality inquiry. In some examples, the capability inquiry may request information regarding whether the UE 104 supports traffic prediction for uplink status reporting.

At 504, the UE 104 may transmit a capability report to the NE 102 in response to the capability inquiry. The capability report may indicate that the UE 104 supports traffic prediction.

At 506, based on the capability report, the NE 102 may transmit a configuration 108 to the UE 104 for uplink status reporting, including parameters for reporting the current uplink status and the predicted uplink status. The configuration 108 may be provided via RRC signaling. The configuration 108 may indicate one or more trigger conditions and a type of uplink status to be reported (e.g., a current uplink status or a predicted uplink status). In some examples, the configuration 108 may include parameters and a format for the uplink status report and, in some cases, for SR and BSR procedures.

At 508, data arrival may occur in a buffer of the UE 104. The data arrival may correspond to uplink data associated with one or more logical channels or QoS flows.

At 510, in response to the data arrival, the UE 104 may transmit the uplink status report 112 for the current uplink status to the NE 102. The uplink status report 112 for the current uplink status may include an SR or a BSR indicating the amount of data currently pending in the buffer of the UE 104.

At 512, the NE 102 may transmit an uplink grant to the UE 104 based on the uplink status report 112 for the current uplink status received at 510. The uplink grant may be a dynamic grant that allocates uplink resources for the UE 104 to transmit the data pending in the buffer.

At 514, an inference outcome for traffic prediction may become available at the UE 104. The inference outcome may correspond to a predicted uplink status for one or more QoS classes, such as QoS1 and QoS2. In some examples, the inference outcome may be generated by a traffic prediction model operating at the UE 104.

At 516, the UE 104 may transmit the uplink status report 112 for the predicted uplink status to the NE 102 on any available resources. The uplink status report 112 for the predicted uplink status may include volume and timing information for each QoS class, such as a volume n1 expected at time t1 for QoS1 and a volume n2 expected at time t2 for QoS2. The uplink status report 112 for the predicted uplink status may be triggered based on the inference outcome being available at the UE 104 in accordance with the one or more trigger conditions indicated by the configuration 108 received at 506.

At 518, data arrival may occur in the buffer of the UE 104 for QoS1 and QoS2, corresponding to the previously predicted traffic.

At 520, the NE 102 may transmit an uplink grant to the UE 104. The uplink grant may be a dynamic grant based on the previously-reported uplink status report 112 for the predicted uplink status.

At 522, the UE 104 may determine whether data is pending in the buffer of the UE 104. This determination may be based on a timer that was initiated (e.g., by and at the UE 104) after the uplink status report 112 for the predicted uplink status was transmitted at 516. The timer may be configured by the NE 102 as part of the configuration 108 at 506, or may be based on UE implementation. The timer represents a delay threshold that monitors how long data remains in the buffer after the uplink status report 112 for the predicted uplink status was transmitted. If the timer expires and data remains pending in the buffer, the UE 104 may determine that the uplink status report 112 for the current uplink status should be transmitted to the NE 102. This timer-based trigger addresses latency-critical traffic scenarios. For such traffic, data that remains in the buffer beyond a configured delay threshold should be reported to the NE 102 regardless of whether the prediction was accurate, because the NE 102 needs to be informed of pending data within a bounded time period to enable timely scheduling decisions. In some examples, the delay threshold may correspond to a remaining time until a packet is discarded or a head-of-line delay for the buffered data.

At 524, based on the determination at 522 that data remains pending in the buffer upon expiry of the timer, the UE 104 may transmit the uplink status report 112 for the current uplink status to the NE 102. The uplink status report 112 for the current uplink status may indicate the volume for QoS2 and may be transmitted via MAC or RRC signaling. The uplink status report 112 for the current uplink status at 524 enables the NE 102 to update its scheduling view with the current buffer status of the UE 104. In some examples, the UE 104 may transmit the uplink status report 112 for the current uplink status at 524 even if the uplink status report 112 for the predicted uplink status transmitted at 516 was accurate. This is because the timer-based trigger is designed to ensure that latency-critical data does not remain in the buffer beyond the configured delay threshold without the NE 102 being informed. Although the UE 104 has already reported the predicted uplink status, the UE 104 may still report the current uplink status for latency-critical data to confirm that the NE 102 has an up-to-date view of the buffer.

The signaling diagram 500 illustrates a trigger condition in which the UE 104 transmits the uplink status report 112 for the current uplink status based on data pending in the buffer of the UE 104 upon expiry of a timer. In contrast to the signaling diagram 400 described with reference to FIG. 4, where the trigger for reporting the current uplink status is based on a deviation between the predicted uplink status and the current uplink status, the signaling diagram 500 illustrates a scenario in which the trigger is time-based. The timer-based trigger may be particularly useful for delay-critical traffic, where the NE 102 should be informed of pending data within a bounded time period regardless of prediction accuracy. The signaling diagram 500 further illustrates that the UE 104 may skip transmitting the uplink status report 112 for the current uplink status for QoS classes where the NE 102 has already allocated sufficient resources based on the uplink status report 112 for the predicted uplink status. The UE 104 may transmit the uplink status report 112 for the current uplink status only for QoS classes where data remains pending in the buffer upon expiry of the timer. This selective reporting may reduce signaling overhead while ensuring that latency-critical data is scheduled in a timely manner.

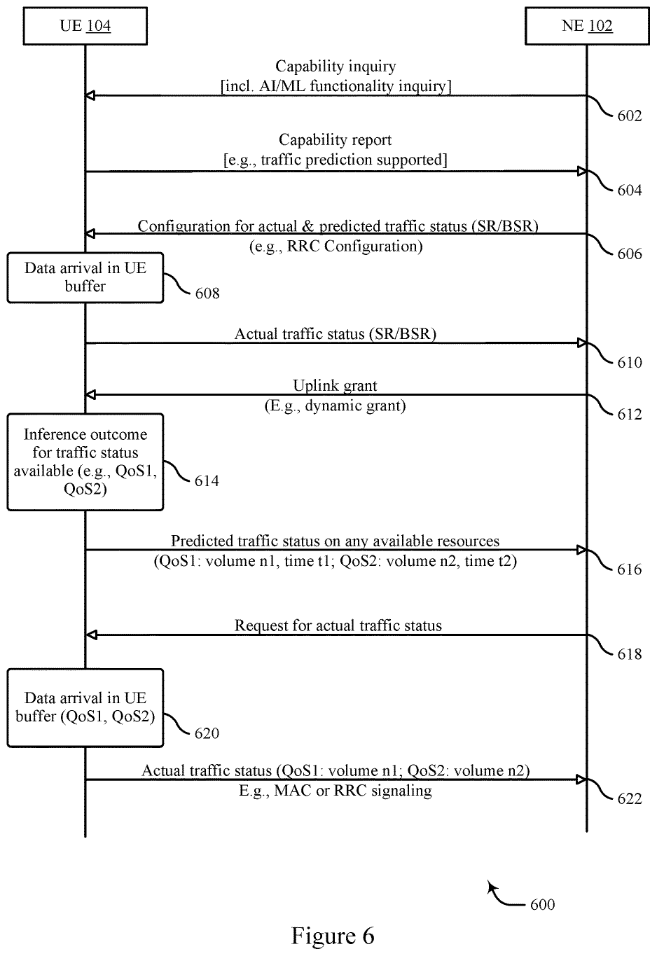

FIG. 6 illustrates an example signaling diagram 600 in accordance with aspects of the present disclosure. In some examples, the signaling diagram 600 implements or is implemented by aspects of the wireless communications system 100. For example, operations of the signaling diagram 600 may be implemented by a UE 104 and an NE 102 as described with reference to FIG. 1. The signaling diagram 600 illustrates how the NE 102 and the UE 104 may coordinate to report predicted and actual traffic status information, where the NE 102 requests an actual traffic status from the UE 104 after receiving a predicted traffic status. The examples described herein are not to be construed as limiting. For example, any network node may perform the operations of the signaling diagram 600.

At 602, the NE 102 may transmit a capability inquiry to the UE 104. The capability inquiry may include an AI/ML functionality inquiry to determine the AI/ML functionalities supported by the UE 104.

At 604, the UE 104 may transmit a capability report to the NE 102 in response to the capability inquiry. The capability report may indicate that the UE 104 supports traffic prediction for uplink status reporting.

At 606, based on the capability report, the NE 102 may transmit a configuration 108 to the UE 104 for uplink status reporting, including parameters for reporting the current uplink status and the predicted uplink status. The configuration 108 may include parameters for SR and BSR procedures, and may be signaled via RRC signaling. The configuration 108 may indicate one or more trigger conditions and a type of uplink status to be reported (e.g., a current uplink status or a predicted uplink status).

At 608, data arrival may occur in a buffer of the UE 104. The data arrival may correspond to uplink data associated with one or more logical channels or QoS flows.

At 610, in response to the data arrival, the UE 104 may transmit the uplink status report 112 for the current uplink status to the NE 102. The uplink status report 112 for the current uplink status may include an SR or a BSR indicating the amount of data currently pending in the buffer of the UE 104.

At 612, the NE 102 may transmit an uplink grant to the UE 104 based on the uplink status report 112 for the current uplink status received at 610. The uplink grant may be a dynamic grant based on the reported current uplink status at 610.

At 614, an inference outcome for traffic prediction may become available at the UE 104. The inference outcome may correspond to a predicted uplink status for one or more QoS classes. In some examples, the inference outcome may be generated by a traffic prediction model operating at the UE 104.

At 616, the UE 104 may transmit the uplink status report 112 for the predicted uplink status to the NE 102 on any available resources. The uplink status report 112 for the predicted uplink status may include volume and timing information for different QoS classes. For example, the uplink status report 112 for the predicted uplink status may indicate a predicted volume and a predicted time of arrival for each QoS class.

At 618, the NE 102 may transmit a request for the uplink status report 112 for the current uplink status to the UE 104. In some examples, the request may be transmitted via control information 110 that includes a field indicating a request for information associated with an uplink status of the UE 104. The field may indicate that the type of the uplink status corresponds to a current uplink status. In some examples, the control information 110 may be signaled within DCI via a PDCCH. In some other examples, the control information 110 may be signaled within a MAC-CE.

The field within the control information 110 may indicate a category of the uplink status, such as a buffer status, a delay status, or a power status. In some examples, the field may comprise a plurality of bits, each bit corresponding to a respective category of the uplink status. By using a multi-bit field, the NE 102 has the flexibility to request only the uplink status information that is relevant to the uplink scheduler at a given time. For example, the NE 102 may request only buffer status information, only delay status information, or a combination thereof, depending on what information the NE 102 needs to evaluate the accuracy of the previously received uplink status report 112 for the predicted uplink status. In some examples, the control information 110 at 618 may further indicate uplink resources for transmission of the uplink status report 112. The indicated uplink resources specify which resources the UE 104 should use for transmitting the requested uplink status report 112 for the current uplink status.

The request at 618 enables the NE 102 to perform explicit monitoring of predictive reporting performance. Although the UE 104 has already transmitted the uplink status report 112 for the predicted uplink status at 616, the NE 102 may want to confirm the prediction by requesting the uplink status report 112 for the current uplink status and comparing the two reports. The NE 102 may transmit the request because the confidence interval or accuracy of the prediction was not sufficient, or because the NE 102 wants to verify the prediction by comparing it with the current uplink status. This on-demand request mechanism is distinct from conventional uplink status reporting, where the UE 104 autonomously triggers reports based on data arrival or periodic timers. Here, the NE 102 initiates the request, giving the NE 102 direct control over when to obtain the uplink status report 112 for the current uplink status from the UE 104.

At 620, data arrival may occur in the buffer of the UE 104 for the QoS classes corresponding to the previously predicted traffic.

At 622, in response to the request at 618, the UE 104 may transmit the uplink status report 112 for the current uplink status to the NE 102. The uplink status report 112 for the current uplink status may indicate the actual volume for each QoS class and may be signaled via MAC or RRC signaling. The uplink status report 112 for the current uplink status at 622 is based on data currently pending in the buffer of the UE 104. The uplink status report 112 comprises information in accordance with the indicated type (e.g., the current uplink status).

Upon receiving the uplink status report 112 for the current uplink status at 622, the NE 102 may compare the uplink status report 112 for the current uplink status with the previously received uplink status report 112 for the predicted uplink status from 616 to determine a prediction accuracy metric. The prediction accuracy metric may include an average error, a distribution of errors, or other performance indicators computed over one or more prediction intervals. Based on the prediction accuracy metric, the NE 102 may take one or more actions. For example, the NE 102 may adapt the configuration 108 for predictive uplink status reporting at the UE 104 by adjusting the prediction window, the trigger conditions, or the report granularity. Additionally, or alternatively, the NE 102 may disable predictive uplink status reporting at the UE 104 if the prediction accuracy metric fails to satisfy a threshold. In some examples, the NE 102 may configure a maximum frequency or rate for such monitoring requests to control signaling overhead.

The signaling diagram 600 illustrates a scenario in which the NE 102 takes an active role in evaluating prediction accuracy by explicitly requesting the uplink status report 112 for the current uplink status from the UE 104. In contrast to the signaling diagrams 400 and 500 described with reference to FIGS. 4 and 5, where the UE 104 autonomously determines when to transmit the uplink status report 112 for the current uplink status based on deviation-based or timer-based trigger conditions, the signaling diagram 600 illustrates a network-initiated approach. The NE 102 has full control over when to request the uplink status report 112 for the current uplink status from the UE 104, and can then compare the uplink status report 112 for the current uplink status with the uplink status report 112 for the predicted uplink status to unambiguously evaluate prediction accuracy. This network-initiated approach addresses a limitation of conventional systems: In conventional systems, an NE cannot determine whether unused uplink grants result from inaccurate predictions or from other causes, such as quantization error of buffer status tables or discarding of PDUs at the UE before transmission. By directly requesting and receiving the uplink status report 112 for the current uplink status, the NE 102 can make informed decisions about whether to continue, adapt, or disable predictive reporting for the UE 104.

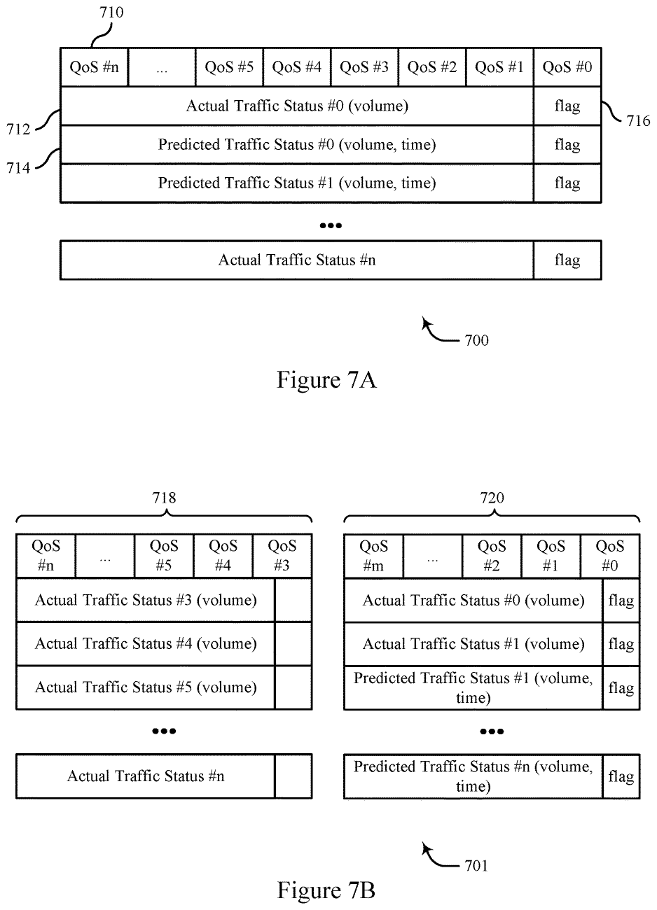

FIGS. 7A through 7C illustrate example uplink status report formats 700, 701, and 702, respectively, in accordance with aspects of the present disclosure. The uplink status report formats described with reference to FIGS. 7A through 7C represent different options for how the UE 104 may structure the uplink status report 112 when reporting the current uplink status and the predicted uplink status to the NE 102. As discussed with reference to FIGS. 3 through 6, the UE 104 may report both the current uplink status based on data currently pending in the buffer and the predicted uplink status based on an inference outcome of a traffic prediction model. The formats described below illustrate how these two types of uplink status information may be structured within the uplink status report 112. The concepts described herein may be applied to uplink status reporting at any granularity, such as per logical channel, per logical channel group, per QoS flow, or per QoS priority class.

FIG. 7A illustrates an example uplink status report format 700 in accordance with aspects of the present disclosure. The uplink status report format 700 illustrates a QoS-class-based format in which the current uplink status and the predicted uplink status are reported together in a single uplink status report 112. The uplink status report format 700 includes QoS fields 710 that each contain an entry for a respective QoS class, e.g., QoS #0 through QoS #n. The QoS fields 710 identify the QoS classes for which uplink status information is being reported.

The uplink status report format 700 further includes one or more actual traffic status fields 712 and one or more predicted traffic status fields 714. Each actual traffic status field 712 corresponds to the current uplink status and includes volume information indicating the amount of data currently pending in the buffer of the UE 104 for the corresponding QoS class. For example, the uplink status report format 700 may include an actual traffic status #0 with volume information for a first set of QoS classes. The uplink status report format 700 may include any number of actual traffic status fields 712, up to and including an actual traffic status #n.

Each predicted traffic status field 714 corresponds to the predicted uplink status of the corresponding QoS class and includes volume information and timing information. The volume information indicates the predicted amount of data expected to arrive at the buffer of the UE 104 for the corresponding QoS class. The timing information indicates when the predicted data volume is expected to arrive. For example, the uplink status report format 700 may include a predicted traffic status #0 and a predicted traffic status #1, each with volume and timing information. The uplink status report format 700 may include any number of predicted traffic status fields 714. By including timing information in the predicted traffic status fields 714, the NE 102 can understand not only how much data is expected but also when the data is expected to arrive. This may allow the NE 102 to schedule uplink resources at the appropriate time.

A respective flag field 716 is associated with each actual traffic status field 712 and each predicted traffic status field 714. The flag field 716 indicates whether the corresponding entry represents the current uplink status or the predicted uplink status. In some examples, the flag field 716 may be a Boolean value that indicates to the NE 102 which entries correspond to the current uplink status and which correspond to the predicted uplink status. For instance, a value of 0 may correspond to (i.e., indicate) a current uplink status and a value of 1 may correspond to (i.e., indicate) a predicted uplink status, or vice versa. The uplink status report format 700 may include any number of actual traffic status fields 712 and predicted traffic status fields 714, each with an associated flag field 716.

The uplink status report format 700 provides a unified format in which both the current uplink status and the predicted uplink status are reported together in a single uplink status report 112. This approach may simplify reporting by using a single format for both types of uplink status information. However, because the current uplink status and the predicted uplink status are reported together, the uplink status report format 700 may provide less flexibility compared to formats that separate the two types of uplink status into distinct reporting structures. For example, the NE 102 may not be able to independently configure or request only the predicted uplink status or only the current uplink status when using the uplink status report format 700.

FIG. 7B illustrates an example uplink status report format 701 in accordance with aspects of the present disclosure. The uplink status report format 701 includes an uplink status report format 718 and an uplink status report format 720, which together illustrate a QoS-class-based format in which separate reporting structures are used for different QoS classes based on priority. This approach enables the NE 102 to configure the UE 104 to report the predicted uplink status for higher-priority QoS classes using the uplink status report format 720, while using legacy reporting (e.g., reporting only the current uplink status) for other QoS classes using the uplink status report format 718.

The uplink status report format 718 includes a header row containing QoS identifiers, such as QoS #3, QoS #4, QoS #5, through QoS #n. Below the header row, the uplink status report format 718 includes entries for actual traffic status #3 (volume), actual traffic status #4 (volume), and actual traffic status #5 (volume), continuing through actual traffic status #n. The uplink status report format 718 corresponds to QoS classes that are not configured as high-priority by the NE 102. For these QoS classes, the UE 104 reports only the current uplink status using legacy reporting behavior.

The uplink status report format 720 includes a header row containing QoS identifiers, such as QoS #0, QoS #1, QoS #2, through QoS #m. Below the header row, the uplink status report format 720 includes entries for actual traffic status #0 (volume) with an associated flag field, actual traffic status #1 (volume) with an associated flag field, and predicted traffic status #1 (volume, time) with an associated flag field. Additional entries may follow, up to #n entries. The uplink status report format 720 corresponds to QoS classes that are configured as high-priority by the NE 102. For these QoS classes, the UE 104 reports both the current uplink status and the predicted uplink status using the uplink status report format 720. As described with reference to FIG. 7A, the flag fields in the uplink status report format 720 distinguish between entries corresponding to the current uplink status and entries corresponding to the predicted uplink status.

By separating the reporting formats based on QoS priority, the NE 102 may configure the UE 104 to provide the predicted uplink status only for QoS classes where advance knowledge of upcoming traffic is most beneficial. For example, the NE 102 may configure the UE 104 to report the predicted uplink status for latency-critical or high-priority traffic using the uplink status report format 720, while lower-priority traffic follows legacy reporting (e.g., reporting only the current uplink status) using the uplink status report format 718. This separation provides the NE 102 with flexibility to target predictive uplink status reporting to specific traffic types without requiring the UE 104 to generate predictions for all QoS classes. The NE 102 may not be interested in having the predicted uplink status reported for all types of traffic. The uplink status report formats 718 and 720 address this by allowing the NE 102 to configure different reporting behavior for different QoS classes.

FIG. 7C illustrates an example uplink status report format 702 in accordance with aspects of the present disclosure. The uplink status report format 702 includes an uplink status report format 722 and an uplink status report format 724, which together illustrate an LCG-based format in which separate reporting structures are used for the current uplink status and the predicted uplink status.

The uplink status report format 722 illustrates a structure for reporting the current uplink status. The uplink status report format 722 includes a header row containing logical channel group identifiers, such as LCG #0 through LCG #n. Below the header row, the uplink status report format 722 includes multiple entries corresponding to the current uplink status. Each entry indicates, for a given LCG, which QoS classes are present and the volume of data for each QoS class. For example, actual traffic status #0 contains QoS #0:vol and QoS #3:vol. Actual traffic status #1 contains QoS #1:vol and QoS #2:vol. Actual traffic status #3 contains QoS #4:vol. Additional entries may follow, up to actual traffic status #n containing QoS #x:vol.

The uplink status report format 722 provides more detailed information than conventional BSR reporting. Conventionally, the BSR is reported only as a volume of data per LCG, which means the NE 102 cannot know how much data belongs to which QoS priority class or logical channel, or which QoS flows are present in the data to be transmitted by the UE 104. By indicating which QoS classes are present within each LCG and the volume for each QoS class, the uplink status report format 722 gives the NE 102 more information on how to schedule uplink resources.

The uplink status report format 724 illustrates a structure for reporting the predicted uplink status. The uplink status report format 724 includes a header row containing logical channel group identifiers, such as LCG #0 through LCG #m. Below the header row, the uplink status report format 724 includes multiple entries corresponding to the predicted uplink status. Each entry includes both volume and timing information for each QoS class. For example, predicted traffic status #0 contains QoS #0:vol,time and QoS #3:vol,time. Predicted traffic status #1 contains QoS #1:vol,time and QoS #2:vol,time. Predicted traffic status #2 contains QoS #4:vol,time. Additional entries may follow, up to predicted traffic status #n containing QoS #x:vol,time. The timing information in the uplink status report format 724 indicates when the predicted data is expected to arrive at the buffer of the UE 104. This enables the NE 102 to understand when predicted data is expected to arrive and to schedule uplink resources accordingly.

The uplink status report formats 722 and 724 provide separate structures for the current uplink status and the predicted uplink status. This separation may allow the NE 102 to process and compare the two types of uplink status information independently. By reporting QoS-class-level detail within each LCG, the uplink status report formats 722 and 724 provide the NE 102 with visibility into the composition of traffic within each LCG. This level of detail may not be available with conventional BSR reporting at the LCG level alone.

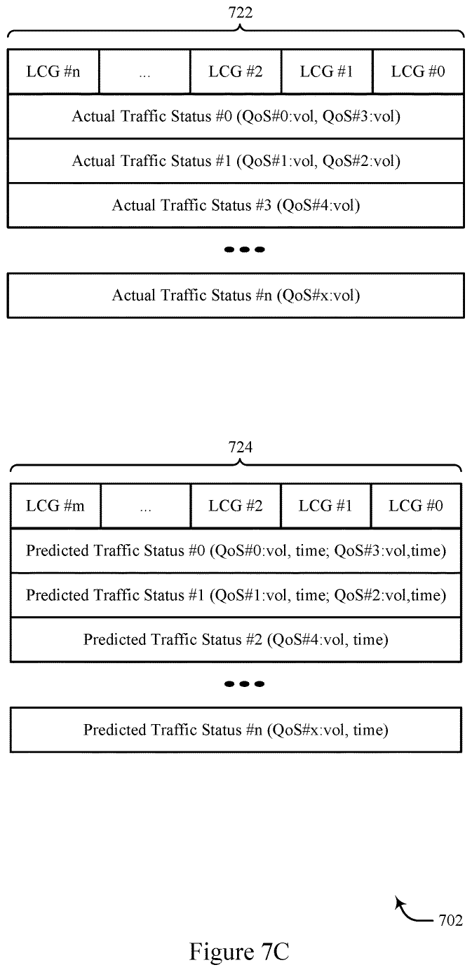

FIG. 8 illustrates an example signaling diagram 800 in accordance with aspects of the present disclosure. In some examples, the signaling diagram 800 implements or is implemented by aspects of the wireless communications system 100. For example, operations of the signaling diagram 800 may be implemented by a UE 104 and an NE 102 as described with reference to FIG. 1. The signaling diagram 800 illustrates how the NE 102 and the UE 104 may coordinate to configure AI/ML traffic related inference and report applicability of the AI/ML configuration. Although the signaling diagram 800 is described with reference to AI/ML-based traffic prediction, the inference configuration may also apply to non-AI/ML-based traffic prediction methods, such as application layer knowledge, packet arrival statistics, or higher-layer indications. The examples described herein are not to be construed as limiting. For example, any network node may perform the operations of the signaling diagram 800.

At 802, the NE 102 may transmit a capability inquiry to the UE 104. The capability inquiry may include an AI/ML functionality inquiry to determine the AI/ML functionalities supported by the UE 104.

At 804, the UE 104 may transmit a capability report to the NE 102 in response to the capability inquiry. The capability report may indicate all supported AI/ML functionalities of the UE 104, including whether the UE 104 supports traffic prediction for uplink status reporting. The capability exchange at 802 and 804 enables the NE 102 to determine which AI/ML functionalities the UE 104 can support before providing an inference configuration to the UE 104.

At 806, based on the capability report, the NE 102 may transmit a full configuration for AI/ML traffic related inference to the UE 104. The configuration may be provided via RRC signaling and may include an inference configuration for traffic prediction. The inference configuration may include parameters such as a duration of a prediction window for which the UE 104 should predict the traffic, filtered traffic types corresponding to high-priority traffic, and a prediction reporting periodicity. In some examples, the configuration may include separate parameters for lower-layer traffic predictions at a MAC layer and higher-layer traffic predictions at an RRC layer. The NE 102 may provide the full inference configuration if the capability report indicates that the UE 104 supports the corresponding AI/ML functionality.

At 808, upon receiving the configuration, the UE 104 may perform an applicability determination to assess whether the AI/ML configuration received at 806 is applicable. The applicability determination may be based on whether the UE 104 has a suitable model to predict for the inference configuration. The applicability determination may also be based on UE conditions, such as memory, battery, or other hardware limitations. Additionally, or alternatively, the applicability determination may be based on network conditions or deployment scenarios. In some examples, the UE 104 may determine that the inference configuration is applicable if the UE 104 has a model that can be activated for the current conditions and configuration. In some other examples, the UE 104 may determine that the inference configuration is inapplicable if the UE 104 does not have a suitable model or if current conditions at the UE 104 are not suitable for the model.

At 810, the UE 104 may transmit an AI/ML applicability report to the NE 102. The applicability report may be included in an RRC reconfiguration complete message and may indicate whether the configuration received at 806 is applicable or inapplicable. The applicability report enables the NE 102 to determine whether the UE 104 can perform inference for traffic prediction based on the provided configuration. In some examples, applicability reporting may be an optional feature for traffic prediction related use cases, depending on the configuration provided by the NE 102. That is, the NE 102 may configure the UE 104 to report applicability information, or the UE 104 may apply the inference configuration without reporting any applicability information.

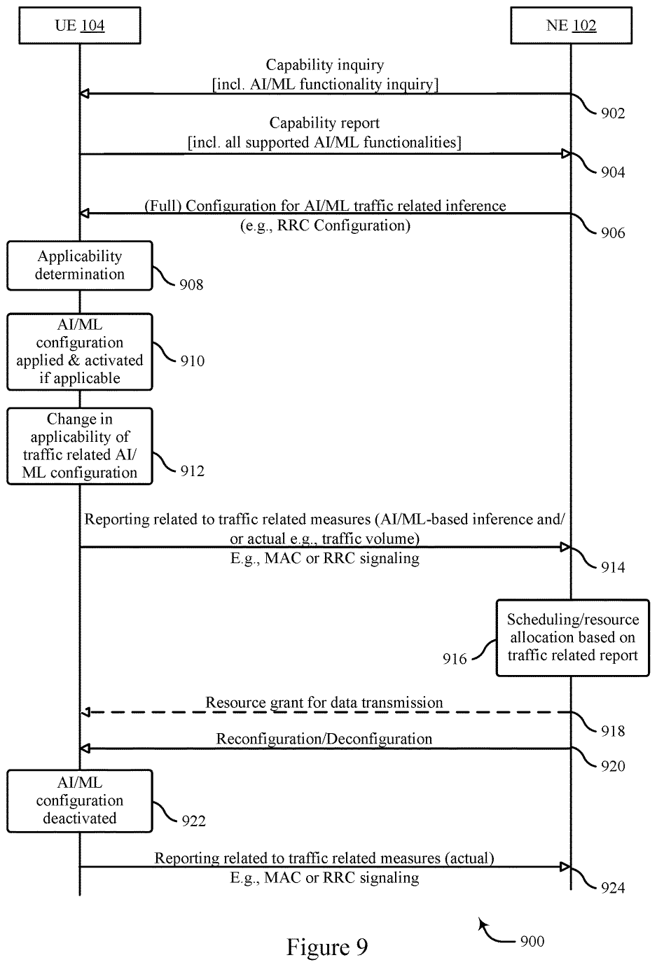

In some examples, applicability reporting for traffic prediction related use cases may be implemented using one of several options. In a first option, the UE 104 may report the applicability of one applicable inference configuration among all inference configurations provided by the NE 102 and may start inference immediately upon reporting. In a second option, the UE 104 may report the applicability of one applicable inference configuration among all inference configurations but may not start inference immediately (e.g., the UE 104 may wait for an activation indication from the NE 102 before starting inference). In a third option, the UE 104 may report applicability for all inference configurations provided by the NE 102, enabling the NE 102 to select which configuration to activate. In a fourth option, the UE 104 may report applicability only for the partial inference configurations, and only one applicable full inference configuration for which it can perform inference, as described with reference to FIG. 10. In a fifth option, the UE 104 does not report any applicability information and may apply the inference configuration based on UE implementation.

At 812, based on the applicability determination at 808, the UE 104 may apply the applicable and configured configuration. The UE 104 may activate the inference configuration and begin performing inference for traffic prediction. In some examples, the UE 104 may activate the configuration upon receiving the configuration from the NE 102. In some other examples, the inference may be performed based on UE implementation, such as depending on the arrival of certain traffic or traffic volume.

At 814, a change in applicability of the traffic related AI/ML configuration may occur at the UE 104. The change in applicability may result from a change in UE conditions, network conditions, or other factors that affect whether the inference configuration remains applicable. For example, the UE 104 may move to a different cell. Additionally, or alternatively, the UE 104 may experience a change in available memory or battery. Additionally, or alternatively, the UE 104 may encounter traffic conditions that differ from those for which the model was trained.

At 816, in response to the change in applicability, the UE 104 may transmit an AI/ML applicability report update to the NE 102. The applicability report update may indicate the updated applicability status, such as a transition from applicable to inapplicable. In some examples, the applicability report update may be transmitted via UAI signaling. The applicability report update enables the NE 102 to be aware that the UE 104 can no longer perform inference for traffic prediction based on the current configuration.

At 818, based on the applicability report update received at 816, the NE 102 may transmit a reconfiguration or deconfiguration message to the UE 104. The reconfiguration may include updated parameters for the AI/ML traffic related inference configuration. The deconfiguration may remove the AI/ML traffic related inference configuration from the UE 104. In some examples, the NE 102 may provide a new inference configuration that is applicable to the current conditions at the UE 104. In some other examples, the NE 102 may deconfigure the AI/ML traffic related inference and rely on legacy uplink status reporting from the UE 104.

The signaling diagram 800 illustrates a scenario in which the NE 102 provides a full inference configuration to the UE 104, and the UE 104 determines and reports the applicability of the configuration. This approach supports the NE 102 in preparing for if and when to expect predicted information related to upcoming traffic. By receiving the applicability report and applicability report updates from the UE 104, the NE 102 can make informed decisions about whether to rely on predicted uplink status information from the UE 104 or to fall back to legacy reporting. The signaling diagram 800 further illustrates that the applicability of the AI/ML configuration may change over time. When such changes occur, the UE 104 may report the changes to the NE 102 to enable the NE 102 to adapt its configuration accordingly.

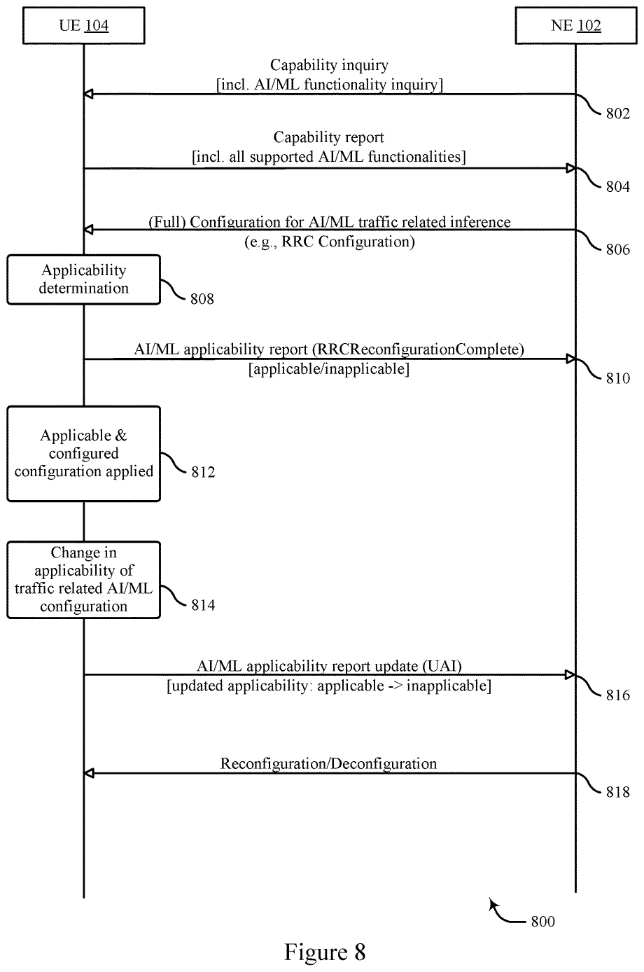

FIG. 9 illustrates an example signaling diagram 900 in accordance with aspects of the present disclosure. In some examples, the signaling diagram 900 implements or is implemented by aspects of the wireless communications system 100. For example, operations of the signaling diagram 900 may be implemented by a UE 104 and an NE 102 as described with reference to FIG. 1. The signaling diagram 900 illustrates how the NE 102 and the UE 104 may coordinate to configure AI/ML traffic related inference, report traffic related measures, and perform scheduling and resource allocation based on the reported measures. Although the signaling diagram 900 is described with reference to AI/ML-based traffic prediction, the inference configuration may also apply to non-AI/ML-based traffic prediction methods, such as application layer knowledge, packet arrival statistics, or higher-layer indications. The examples described herein are not to be construed as limiting. For example, any network node may perform the operations of the signaling diagram 900.

At 902, the NE 102 may transmit a capability inquiry to the UE 104. The capability inquiry may include an AI/ML functionality inquiry to determine the AI/ML functionalities supported by the UE 104.

At 904, the UE 104 may transmit a capability report to the NE 102 in response to the capability inquiry. The capability report may indicate all supported AI/ML functionalities of the UE 104, including whether the UE 104 supports traffic prediction for uplink status reporting.

At 906, based on the capability report, the NE 102 may transmit a full configuration for AI/ML traffic related inference to the UE 104. The configuration may be provided via RRC signaling and may include an inference configuration for traffic prediction. The inference configuration may include parameters such as a duration of a prediction window, filtered traffic types corresponding to high-priority traffic, and a prediction reporting periodicity. In some examples, the configuration may include separate parameters for lower-layer traffic predictions at a MAC layer and higher-layer traffic predictions at an RRC layer.

At 908, upon receiving the configuration, the UE 104 may perform an applicability determination to assess whether the AI/ML configuration received at 906 is applicable. The applicability determination may be based on whether the UE 104 has a suitable model to predict for the inference configuration, UE conditions, network conditions, or deployment scenarios. In contrast to the signaling diagram 800 described with reference to FIG. 8, where the UE 104 transmits an explicit applicability report to the NE 102 before applying the configuration, the signaling diagram 900 illustrates a scenario in which the UE 104 performs the applicability determination internally and proceeds to apply the configuration if applicable without first reporting applicability.

At 910, based on the applicability determination at 908, the UE 104 may apply and activate the AI/ML configuration if applicable. The UE 104 may begin performing inference for traffic prediction based on the activated configuration. In some examples, the UE 104 may activate the configuration upon receiving the configuration from the NE 102. In some other examples, the inference may be performed based on UE implementation, such as depending on the arrival of certain traffic or traffic volume.

At 912, the UE 104 may determine that a change in applicability of the traffic related AI/ML configuration has occurred. The change in applicability may result from a change in UE conditions, network conditions, or other factors that affect whether the inference configuration remains applicable. For example, the UE 104 may move to a different cell, experience a change in available memory or battery, or encounter traffic conditions that differ from those for which the model was trained.

At 914, the UE 104 may transmit reporting related to traffic related measures to the NE 102. The reporting may include AI/ML-based inference outcomes and/or actual traffic information, such as traffic volume. The reporting may be performed via MAC or RRC signaling. In some examples, the reporting may include predicted traffic status based on the inference outcome, actual traffic status based on data currently pending in the buffer of the UE 104, or a combination thereof. The reporting at 914 may correspond to the uplink status report 112 described with reference to FIG. 1.

In some examples, the UE 104 may report predicted traffic characteristics in the same format as actual traffic characteristics. It may be up to UE implementation how the UE 104 determines the traffic characteristics. The UE 104 may apply AI/ML models to predict the traffic behavior and respective parameters. In some other examples, the NE 102 may need to be aware of whether the reported traffic information is prediction-based or based on actual traffic. In such cases, it may be desirable to differentiate the reporting of prediction-based outcomes from actual outcomes. The NE 102 may configure the UE 104 to report the actual traffic-related parameters and prediction-based parameters individually, such as using separate RRC configurations and/or formatting as described with reference to FIGS. 7A through 7C.

In some examples, the inference outcome related to traffic prediction may be signaled as lower-layer reporting over the MAC layer. In some other examples, the inference outcome may be signaled over higher layers, such as RRC signaling. Traffic-related predictions over a longer time scale may support the NE 102 in making decisions related to modifications to configurations such as SR configurations, BSR configurations, discontinuous reception (DRX) parameters, reconfiguring logical channels, handover decisions, or decisions related to RRC states.

At 916, the NE 102 may perform scheduling and resource allocation based on the traffic related report received at 914. For example, the NE 102 may pre-allocate uplink resources for one or more future transmission occasions based on the predicted traffic status. Additionally, or alternatively, the NE 102 may allocate uplink resources based on the actual traffic status.

At 918, the NE 102 may transmit a resource grant for data transmission to the UE 104. The resource grant may be based on the scheduling and resource allocation performed at 916.

At 920, the NE 102 may transmit a reconfiguration or deconfiguration message to the UE 104. The reconfiguration may include updated parameters for the AI/ML traffic related inference configuration. The deconfiguration may remove the AI/ML traffic related inference configuration from the UE 104. The NE 102 may transmit the reconfiguration or deconfiguration based on the traffic related measures received at 914, the scheduling outcomes at 916, or other factors such as prediction accuracy or changes in network conditions.

At 922, in response to a deconfiguration indication received at 920, the UE 104 may deactivate the AI/ML configuration. Upon deactivation, the UE 104 may fall back to non-AI/ML operation for uplink status reporting. That is, the UE 104 may no longer rely on the inference process for generating predicted uplink status information.

At 924, following deactivation of the AI/ML configuration, the UE 104 may transmit reporting related to traffic related measures to the NE 102. The reporting at 924 includes actual traffic measures rather than AI/ML-based inference outcomes. The reporting may be performed via MAC or RRC signaling. The reporting at 924 represents the fallback to legacy reporting behavior, where the UE 104 reports actual buffer status, delay status, or other uplink status information based on data currently pending in the buffer of the UE 104.

In contrast to the signaling diagram 800 described with reference to FIG. 8, which focuses on applicability determination and reporting, the signaling diagram 900 illustrates how the NE 102 uses the traffic related measures reported by the UE 104 to perform scheduling and resource allocation. The signaling diagram 900 further illustrates that the NE 102 may subsequently reconfigure or deconfigure the AI/ML inference based on the outcomes. Upon deactivation, the UE 104 falls back to reporting actual traffic measures. This ensures that the NE 102 continues to receive uplink status information for scheduling purposes even when AI/ML-based inference is no longer active.

FIG. 10 illustrates an example signaling diagram 1000 in accordance with aspects of the present disclosure. In some examples, the signaling diagram 1000 implements or is implemented by aspects of the wireless communications system 100. For example, operations of the signaling diagram 1000 may be implemented by a UE 104 and an NE 102 as described with reference to FIG. 1. The signaling diagram 1000 illustrates how the NE 102 and the UE 104 may coordinate to manage AI/ML lifecycle for traffic related inference, including partial and full configuration, applicability reporting, and deactivation of the AI/ML configuration. Although the signaling diagram 1000 is described with reference to AI/ML-based traffic prediction, the inference configuration may also apply to non-AI/ML-based traffic prediction methods, such as application layer knowledge, packet arrival statistics, or higher-layer indications. The examples described herein are not to be construed as limiting. For example, any network node may perform the operations of the signaling diagram 1000.

At 1002, the NE 102 may transmit a capability inquiry to the UE 104. The capability inquiry may include an AI/ML functionality inquiry to determine the AI/ML functionalities supported by the UE 104.

At 1004, the UE 104 may transmit a capability report to the NE 102 in response to the capability inquiry. The capability report may indicate all supported AI/ML functionalities of the UE 104, including whether the UE 104 supports traffic prediction for uplink status reporting.

At 1006, based on the capability report, the NE 102 may transmit a partial configuration for applicable AI/ML functionalities to the UE 104. The partial configuration may include one or more parameters related to an inference configuration, such as a subset of the parameters that would be included in a full inference configuration. The partial configuration may be signaled via RRC signaling. In contrast to the signaling diagrams 800 and 900 described with reference to FIGS. 8 and 9, where the NE 102 provides a full inference configuration directly, the signaling diagram 1000 illustrates a two-phase approach. In this approach, the NE 102 first provides a partial configuration to determine which configurations are applicable at the UE 104 before providing a full configuration.

At 1008, upon receiving the partial configuration, the UE 104 may evaluate which configurations are applicable. The UE 104 may determine one of the partial inference configurations for which it can perform inference. For example, the UE 104 may determine whether it has a suitable model to predict for the inference configuration containing a prediction of a certain traffic type or within a certain prediction window. The applicability determination may also be based on UE conditions, network conditions, or deployment scenarios, among other examples.

At 1010, the UE 104 may transmit an AI/ML applicability report to the NE 102 via an RRC reconfiguration complete message. The applicability report may indicate the applicable configurations among the partial configurations received at 1006. By reporting which partial configurations are applicable, the UE 104 enables the NE 102 to select an appropriate full configuration that the UE 104 can support.

At 1012, based on the applicability report received at 1010, the NE 102 may transmit a full configuration for AI/ML traffic related inference to the UE 104. The full configuration may be signaled via RRC signaling. The full configuration may correspond to the applicable partial configuration indicated by the UE 104. The full configuration may include an inference configuration for traffic prediction with parameters such as a duration of a prediction window, filtered traffic types corresponding to high-priority traffic, and a prediction reporting periodicity. In some examples, the full configuration may include separate parameters for lower-layer traffic predictions at a MAC layer and higher-layer traffic predictions at an RRC layer.

At 1014, the UE 104 may apply and activate the AI/ML configuration if applicable. The UE 104 may begin performing inference for traffic prediction based on the activated configuration.

At 1016, the UE 104 may transmit reporting related to traffic related measures to the NE 102. The reporting may include AI/ML-based inference outcomes and/or actual traffic information, such as traffic volume. The reporting may be transmitted via MAC or RRC signaling. The reporting at 1016 may correspond to the uplink status report 112 described with reference to FIG. 1.

At 1018, the NE 102 may perform scheduling and resource allocation using the received traffic related measures. The NE 102 may pre-allocate uplink resources for one or more future transmission occasions based on the predicted traffic status. Additionally, or alternatively, the NE 102 may allocate uplink resources based on the actual traffic status.

At 1020, the NE 102 may transmit a resource grant for data transmission to the UE 104. The resource grant may be based on the scheduling and resource allocation performed at 1018.

At 1022, the UE 104 may determine that a change in applicability of the traffic related AI/ML configuration has occurred. The change in applicability may result from a change in UE conditions, network conditions, or other factors that affect whether the inference configuration remains applicable. For example, the UE 104 may move to a different cell. Additionally, or alternatively, the UE 104 may experience a change in available memory or battery. Additionally, or alternatively, the UE 104 may encounter traffic conditions that differ from those for which the model was trained.

At 1024, in response to the change in applicability, the UE 104 may transmit an AI/ML applicability report update to the NE 102. The applicability report update may indicate updated applicability information, such as a transition from applicable to inapplicable for the current inference configuration.

At 1026, based on the applicability report update received at 1024, the NE 102 may transmit a reconfiguration or deconfiguration message to the UE 104. The reconfiguration may include updated parameters for the AI/ML traffic related inference configuration. The deconfiguration may remove the AI/ML traffic related inference configuration from the UE 104.

At 1028, in response to a deconfiguration indication received at 1026, the UE 104 may deactivate the AI/ML configuration. Upon deactivation, the UE 104 may fall back to non-AI/ML operation for uplink status reporting.

At 1030, following deactivation of the AI/ML configuration, the UE 104 may transmit reporting related to actual traffic related measures to the NE 102. The reporting at 1030 may be transmitted via MAC or RRC signaling. The reporting at 1030 represents a fallback to legacy reporting behavior, where the UE 104 reports actual buffer status, delay status, or other uplink status information based on data currently pending in the buffer of the UE 104.

The signaling diagram 1000 illustrates a two-phase configuration approach in which the NE 102 first provides a partial configuration to determine applicability and then provides a full configuration based on the UE 104′s applicability report. This approach may be useful when the NE 102 does not know in advance which inference configurations are applicable at the UE 104. By first providing partial configurations and receiving an applicability report, the NE 102 can avoid configuring the UE 104 with a full inference configuration that the UE 104 cannot support. The signaling diagram 1000 further illustrates the end-to-end lifecycle from partial configuration through full configuration, inference reporting, scheduling, applicability change, and eventual deactivation with fallback to actual reporting. In contrast to the signaling diagram 800 described with reference to FIG. 8, which illustrates applicability determination and reporting without inference reporting, and the signaling diagram 900 described with reference to FIG. 9, which illustrates full configuration without a preceding partial configuration, the signaling diagram 1000 combines both the partial-to-full configuration approach and the inference reporting and deactivation flow.

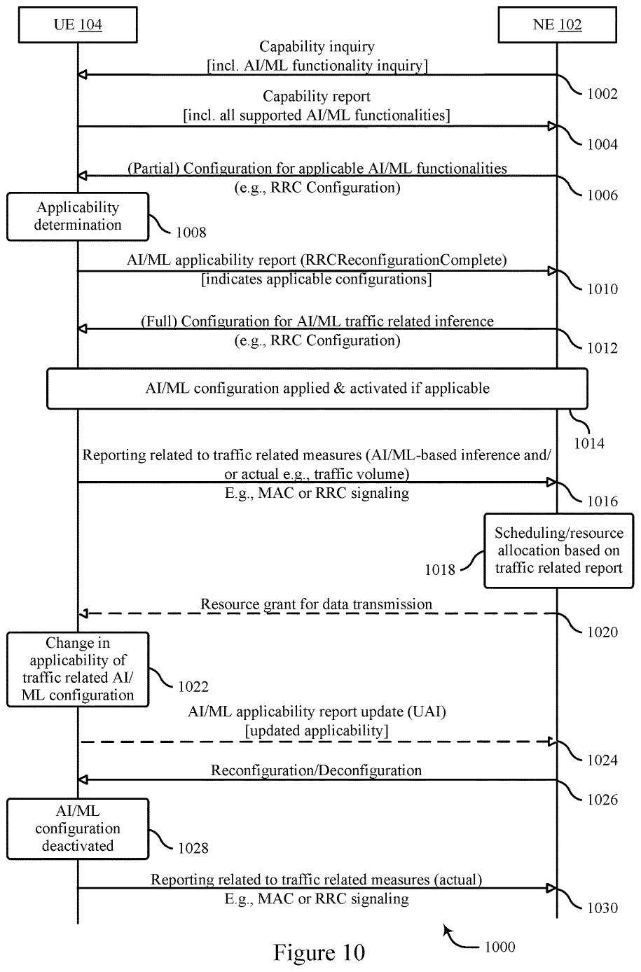

FIG. 11 illustrates an example signaling diagram 1100 in accordance with aspects of the present disclosure. In some examples, the signaling diagram 1100 implements or is implemented by aspects of the wireless communications system 100. For example, operations of the signaling diagram 1100 may be implemented by a UE 104 and an NE 102 as described with reference to FIG. 1. The signaling diagram 1100 illustrates how the NE 102 and the UE 104 may coordinate to perform AI/ML traffic related performance monitoring, where the NE 102 initiates the performance monitoring and performs management decisions for AI/ML related traffic predictions. The examples described herein are not to be construed as limiting. For example, any network node may perform the operations of the signaling diagram 1100.

At 1102, the NE 102 may transmit a capability inquiry to the UE 104. The capability inquiry may include an AI/ML functionality inquiry to determine the AI/ML functionalities supported by the UE 104.

At 1104, the UE 104 may transmit a capability report to the NE 102 in response to the capability inquiry. The capability report may indicate all supported AI/ML functionalities of the UE 104, including whether the UE 104 supports traffic prediction for uplink status reporting.

At 1106, based on the capability report, the NE 102 may initiate AI/ML traffic related performance monitoring. The NE 102 may determine that performance monitoring is needed to evaluate the accuracy of the UE 104′s traffic predictions as reflected in the uplink status reports 112 for the predicted uplink status. Based on this evaluation, the NE 102 may make management decisions regarding the AI/ML configuration at the UE 104, such as whether to continue, reconfigure, or disable predictive uplink status reporting.

At 1108, the NE 102 may transmit a configuration 108 for AI/ML traffic related performance monitoring to the UE 104. The configuration 108 may be provided via RRC signaling. The configuration 108 may include parameters such as performance measures to report, accuracy of prediction metrics, ground truth values, or predicted values. In some examples, the configuration 108 may specify which traffic-related performance measures the UE 104 should report to the NE 102. In some other examples, the NE 102 may conduct performance monitoring based on the uplink status reports 112 for the predicted uplink status and the uplink status reports 112 for the current uplink status received from the UE 104 without requiring the UE 104 to report specific performance monitoring metrics. That is, the NE 102 may compare the uplink status reports 112 for the predicted uplink status and the uplink status reports 112 for the current uplink status that the UE 104 transmits as part of normal uplink status reporting, rather than requiring a separate performance monitoring report.

At 1110, the UE 104 may apply the AI/ML configuration if inference is activated. The UE 104 may begin performing inference for traffic prediction based on the configuration 108 received at 1108. In some examples, the UE 104 may apply the configuration 108 upon receiving it from the NE 102. In some other examples, the UE 104 may apply the configuration 108 based on UE implementation.

At 1112, the UE 104 may transmit reporting related to traffic related performance measures to the NE 102. The reporting may be performed via MAC or RRC signaling. The reporting may include performance measures such as prediction accuracy, ground truth values (e.g., the current uplink status including actual buffer status or delay status), predicted values (e.g., the predicted uplink status), or other metrics that enable the NE 102 to evaluate the performance of the AI/ML traffic prediction at the UE 104. In some examples, the reporting may include both the uplink status report 112 for the predicted uplink status and the uplink status report 112 for the current uplink status. This enables the NE 102 to compare the two and compute prediction performance indicators.

At 1114, the NE 102 may perform management and decision making for AI/ML related traffic predictions based on the reporting received at 1112. The NE 102 may compare the uplink status report 112 for the predicted uplink status with the uplink status report 112 for the current uplink status to compute prediction performance indicators, such as an average error or a distribution of errors. Based on these indicators, the NE 102 may determine whether the AI/ML traffic prediction at the UE 104 is performing at a sufficient level. For example, if the prediction accuracy satisfies a threshold, the NE 102 may continue with the current configuration 108. If the prediction accuracy does not satisfy the threshold, the NE 102 may determine that the AI/ML configuration should be reconfigured or deconfigured.

At 1116, based on the management and decision making at 1114, the NE 102 may transmit a reconfiguration or deconfiguration message to the UE 104. The reconfiguration may include updated parameters for the AI/ML traffic related inference configuration within the configuration 108, such as adjusted prediction windows, different trigger conditions, or modified report granularity. The deconfiguration may remove the AI/ML traffic related inference configuration from the UE 104. In some examples, the NE 102 may disable predictive uplink status reporting at the UE 104 if the prediction accuracy metric fails to satisfy the threshold.

At 1118, in response to the reconfiguration or deconfiguration received at 1116, the UE 104 may deactivate or switch the AI/ML configuration. If the NE 102 transmitted a deconfiguration, the UE 104 may deactivate the AI/ML configuration and fall back to legacy uplink status reporting (e.g., transmitting the uplink status report 112 for the current uplink status only). If the NE 102 transmitted a reconfiguration, the UE 104 may switch to a new AI/ML configuration with updated parameters.

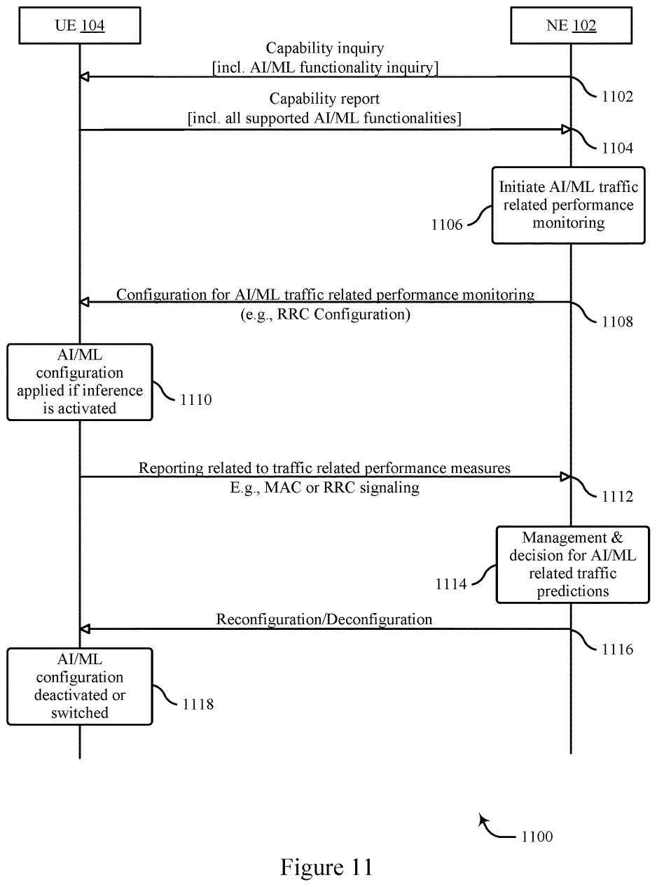

The signaling diagram 1100 illustrates NE-initiated, NE-decision performance monitoring. In this approach, the NE 102 initiates the performance monitoring, configures the UE 104 with the performance monitoring parameters via the configuration 108, receives the performance measures from the UE 104, and makes the management decisions regarding whether to continue, reconfigure, or deconfigure the AI/ML traffic prediction. The NE 102 has full control over the performance monitoring process and the resulting management decisions. This approach enables the NE 102 to selectively enable, parameterize, or disable predictive uplink status reporting per UE, so that prediction-based scheduling is used when it delivers sufficient performance gains. In contrast to the signaling diagram 1200 described with reference to FIG. 12, where the UE 104 initiates the performance monitoring and performs the management decisions, the signaling diagram 1100 illustrates a network-centric approach in which the NE 102 drives the performance monitoring lifecycle.

FIG. 12 illustrates an example signaling diagram 1200 in accordance with aspects of the present disclosure. In some examples, the signaling diagram 1200 implements or is implemented by aspects of the wireless communications system 100. For example, operations of the signaling diagram 1200 may be implemented by a UE 104 and an NE 102 as described with reference to FIG. 1. The signaling diagram 1200 illustrates how the NE 102 and the UE 104 may coordinate to perform AI/ML traffic related performance monitoring, where the UE 104 initiates the performance monitoring and performs management decisions for AI/ML related traffic predictions. The examples described herein are not to be construed as limiting. For example, any network node may perform the operations of the signaling diagram 1200.

At 1202, the NE 102 may transmit a capability inquiry to the UE 104. The capability inquiry may include an AI/ML functionality inquiry to determine the AI/ML functionalities supported by the UE 104.

At 1204, the UE 104 may transmit a capability report to the NE 102 in response to the capability inquiry. The capability report may indicate all supported AI/ML functionalities of the UE 104, including whether the UE 104 supports traffic prediction for uplink status reporting.

At 1206, based on the capability report, the NE 102 may transmit a configuration 108 for AI/ML traffic related performance monitoring to the UE 104. The configuration 108 may be provided via RRC signaling. In contrast to the signaling diagram 1100 described with reference to FIG. 11, where the NE 102 initiates the performance monitoring and performs the management decisions, the signaling diagram 1200 illustrates a scenario in which the UE 104 takes the lead in initiating the performance monitoring and performing the management decisions. The configuration 108 at 1206 may include parameters that enable the UE 104 to perform performance monitoring, such as performance thresholds, accuracy criteria, or other parameters that the UE 104 may use to evaluate the performance of its own traffic predictions.

At 1208, upon receiving the configuration 108, the UE 104 may initiate AI/ML traffic related performance monitoring. The UE 104 may begin monitoring the performance of its traffic predictions by comparing the uplink status report 112 for the predicted uplink status with the uplink status report 112 for the current uplink status as data arrives at the buffer of the UE 104. The performance monitoring is primarily the role of the entity that performs the AI/ML inference. Because the UE 104 performs the inference for traffic prediction, the UE 104 has direct access to both the predicted uplink status and the current uplink status. This positions the UE 104 to evaluate prediction performance without requiring the NE 102 to request and compare the uplink status report 112 for the current uplink status.

At 1210, the UE 104 may perform AI/ML related traffic predictions and management decisions related to those predictions. The UE 104 may generate inference outcomes for one or more QoS classes based on the activated inference configuration. The UE 104 may use the inference outcomes to generate the uplink status report 112 for the predicted uplink status for reporting to the NE 102. Additionally, the UE 104 may evaluate the performance of the traffic predictions, such as by comparing the uplink status report 112 for the predicted uplink status with the uplink status report 112 for the current uplink status. Based on this evaluation, the UE 104 may make management decisions regarding whether to continue performing inference, adjust the inference configuration, or stop performing inference. In contrast to the signaling diagram 1100 described with reference to FIG. 11, where the NE 102 performs the management and decision making at 1114, the signaling diagram 1200 illustrates a scenario in which the UE 104 performs both the inference and the management decisions locally.

At 1212, the UE 104 may transmit reporting related to traffic related performance measures to the NE 102. The reporting may be transmitted via MAC or RRC signaling. The reporting may include the UE 104′s assessment of prediction performance, such as a prediction accuracy metric or a decision regarding whether to continue performing inference. In some examples, the reporting may include both the uplink status report 112 for the predicted uplink status and the uplink status report 112 for the current uplink status, enabling the NE 102 to have visibility into the UE 104's traffic prediction performance. In some other examples, the UE 104 may report only the final outcome of the performance monitoring. For example, the UE 104 may report an indication that the UE 104 has determined that its predictions are no longer sufficiently accurate.

At 1214, based on the reporting received at 1212, the NE 102 may transmit a reconfiguration or deconfiguration message to the UE 104. The reconfiguration may include updated parameters for the AI/ML traffic related performance monitoring or the AI/ML traffic related inference configuration within the configuration 108. The deconfiguration may remove the AI/ML traffic related performance monitoring configuration or the AI/ML traffic related inference configuration from the UE 104. In some examples, the NE 102 may transmit the reconfiguration or deconfiguration based on the UE 104′s reported performance monitoring outcome. In some other examples, the NE 102 may independently determine that reconfiguration or deconfiguration is appropriate based on the performance measures reported by the UE 104.

At 1216, in response to the reconfiguration or deconfiguration received at 1214, the UE 104 may deactivate or switch the AI/ML configuration. If the NE 102 transmitted a deconfiguration, the UE 104 may deactivate the AI/ML configuration and fall back to legacy uplink status reporting (e.g., transmitting the uplink status report 112 for the current uplink status only). If the NE 102 transmitted a reconfiguration, the UE 104 may switch to a new AI/ML configuration with updated parameters, e.g., according to the reconfiguration. In some examples, the UE 104 may have already paused or stopped performing inference and reporting the uplink status report 112 for the predicted uplink status prior to receiving the reconfiguration or deconfiguration. This may occur when the UE 104's own performance monitoring has determined that the performance is below the expected performance measures. In such cases, the reconfiguration or deconfiguration from the NE 102 may confirm the UE 104's decision and formalize the change in the configuration 108.

The signaling diagram 1200 illustrates UE-initiated, UE-decision performance monitoring. In this approach, the UE 104 initiates the performance monitoring, evaluates the performance of its own traffic predictions, and performs management decisions regarding whether to continue performing inference. The UE 104 may indicate its final outcome to the NE 102, enabling the NE 102 to adapt the configuration 108 accordingly. In contrast to the signaling diagram 1100 described with reference to FIG. 11, where the NE 102 drives the performance monitoring lifecycle and makes the management decisions, the signaling diagram 1200 illustrates a UE-centric approach. The UE-centric approach may be appropriate when the UE 104 has direct access to both the uplink status report 112 for the predicted uplink status and the uplink status report 112 for the current uplink status and can evaluate prediction performance locally. The signaling diagram 1200 further illustrates that even in the UE-initiated approach, the NE 102 retains the ability to reconfigure or deconfigure the AI/ML configuration based on the UE 104′s reported performance monitoring outcome.

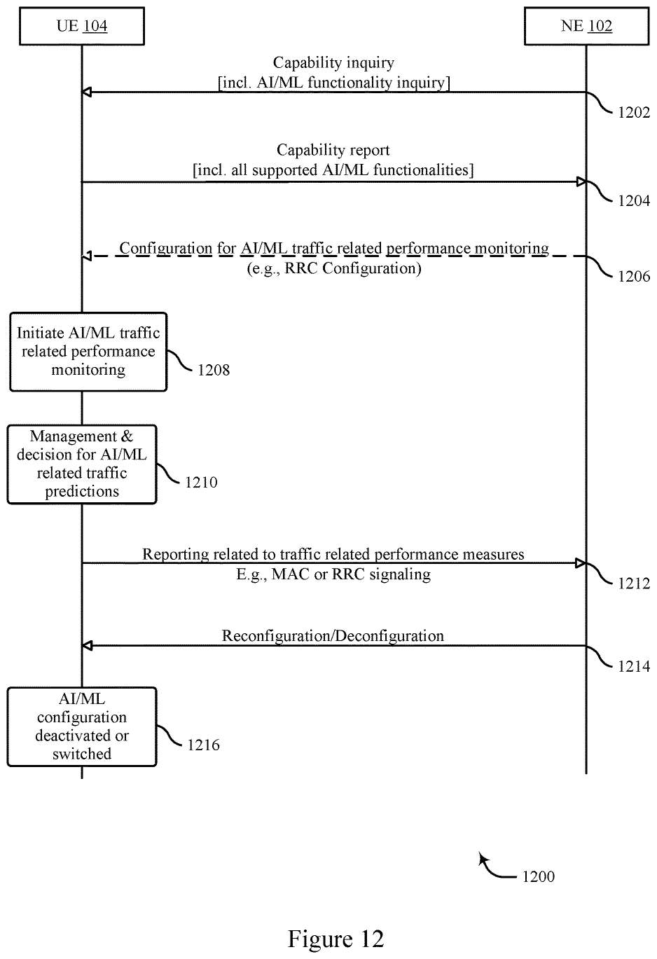

FIGS. 13A through 13C illustrate example traffic prediction processes 1300, 1301, and 1302, respectively, in accordance with aspects of the present disclosure. The traffic prediction processes 1300, 1301, and 1302 represent different alternatives for how traffic prediction may be distributed between different protocol layers within the UE 104. As described with reference to FIG. 1, the UE 104 may perform inference based on information available at lower layers, such as the MAC layer, about upcoming or past traffic patterns in the UE 104's buffer. Additionally, or alternatively, the UE 104 may perform inference at higher layers, such as the RRC layer, based on information available at or received from lower layers. At higher layers, information such as the number of active data radio bearers, mapping of bearers, and signaling radio bearer configurations may be available. However, information related to traffic volume or exact buffer occupancy at the lower layers may not be directly known at the higher layers. The three alternatives described below illustrate different approaches for distributing the traffic prediction functionality between these layers. The inference outcomes produced by these traffic prediction processes may be used by the UE 104 to generate the uplink status report 112 for the predicted uplink status as described herein.

FIG. 13A illustrates an example traffic prediction process 1300 in accordance with aspects of the present disclosure. The traffic prediction process 1300 depicts a hierarchical architecture for uplink traffic prediction that may be implemented by the UE 104.

The traffic prediction process 1300 includes a lower-layer traffic prediction module and a higher-layer traffic module arranged in a sequential configuration. The lower-layer traffic prediction module receives data arrival statistics and traffic assistance information as inputs. The data arrival statistics may include information related to past buffer status, such as past SRs and BSRs, as well as traffic type information. The traffic assistance information may include additional context or parameters that assist in generating predictions. In some examples, the inputs for the lower-layer traffic prediction module may include past buffer status of the UE 104 for overall traffic types. In some other examples, individual traffic types may be analyzed separately to predict the upcoming traffic volume.

Based on these inputs, the lower-layer traffic prediction module generates prediction outcomes for one or more time instances. The lower-layer traffic prediction module may operate at the MAC layer. The prediction outcomes from the lower-layer traffic prediction module are then provided to the higher-layer traffic module. The higher-layer traffic module processes the prediction outcomes and produces a final prediction or computation outcome. The higher-layer traffic module may operate at the RRC layer.

In the traffic prediction process 1300, the lower-layer traffic prediction module performs the prediction, and the higher-layer traffic module processes the lower-layer prediction outcomes to derive the final outcome. The higher-layer traffic module may apply filtering or averaging operations to the lower-layer predictions to derive longer-term traffic statistics. These longer-term statistics may support the NE 102 in performing scheduling and resource allocation decisions based on the uplink status report 112 for the predicted uplink status. For example, the higher-layer traffic module may average the raw prediction outcomes received from the lower-layer traffic prediction module over a longer time scale. The averaging or filtering may be performed either individually for each traffic type or consolidated for the entire traffic volume.

FIG. 13B illustrates an example traffic prediction process 1301 in accordance with aspects of the present disclosure. The traffic prediction process 1301 depicts a hierarchical architecture for traffic prediction that is similar to the traffic prediction process 1300 described with reference to FIG. 13A, but with prediction performed at both the lower layer and the higher layer.

The traffic prediction process 1301 includes a lower-layer traffic prediction module and a higher-layer traffic prediction module arranged in a sequential configuration. The lower-layer traffic prediction module receives data arrival statistics and traffic assistance information as inputs. Based on these inputs, the lower-layer traffic prediction module generates prediction outcomes for one or more time instances. The lower-layer traffic prediction module may operate at the MAC layer.

The prediction outcomes from the lower-layer traffic prediction module are provided as input to the higher-layer traffic prediction module. The higher-layer traffic prediction module processes the lower-layer prediction outcomes to generate a prediction or computation outcome. The higher-layer traffic prediction module may operate at the RRC layer. In contrast to the traffic prediction process 1300 described with reference to FIG. 13A, where the higher-layer module processes lower-layer predictions without performing its own prediction, the traffic prediction process 1301 includes a higher-layer traffic prediction module that performs its own prediction operations based on the lower-layer prediction outcomes. This arrangement allows the traffic prediction process 1301 to derive long-term statistics or refined predictions by processing the raw prediction outcomes received from the lower layer over a longer time scale.

The traffic prediction process 1301 may be implemented at the UE 104 to predict uplink traffic characteristics such as traffic volume, traffic type, traffic duration, buffer status, or delay status. The prediction or computation outcome generated by the higher-layer traffic prediction module may be used to generate the uplink status report 112 for the predicted uplink status. The uplink status report 112 for the predicted uplink status may be transmitted to the NE 102 to enable proactive scheduling and resource allocation decisions.

FIG. 13C illustrates an example traffic prediction process 1302 in accordance with aspects of the present disclosure. The traffic prediction process 1302 depicts a hierarchical architecture in which the lower layer collects and aggregates traffic statistics rather than performing prediction. The higher layer then performs the prediction based on the aggregated statistics.

The traffic prediction process 1302 includes a lower-layer traffic module and a higher-layer traffic prediction module. The lower-layer traffic module receives data arrival statistics and traffic assistance information as inputs. In contrast to the traffic prediction processes 1300 and 1301 described with reference to FIGS. 13A and 13B, where the lower-layer module performs prediction, the lower-layer traffic module in the traffic prediction process 1302 does not perform prediction itself. Instead, the lower-layer traffic module collects and aggregates the input data and generates traffic statistics over a long period as an output. The lower-layer traffic module may operate at the MAC layer.

The traffic statistics over the long period are then provided to the higher-layer traffic prediction module. The higher-layer traffic prediction module processes the traffic statistics received from the lower-layer traffic module and generates a prediction or computation outcome. The higher-layer traffic prediction module may operate at the RRC layer. This arrangement enables the UE 104 to derive long-term traffic characteristics by filtering or averaging lower-layer statistics over an extended time scale. The higher-layer traffic prediction module performs the inference or prediction operations based on the aggregated information. The prediction or computation outcome may be used to generate the uplink status report 112 for the predicted uplink status, supporting more accurate predictive uplink status reporting to the NE 102.

The NE 102 may configure the UE 104 to compute traffic-related information at lower layers and higher layers separately via the configuration 108. The configuration 108 may include parameters defining the relation between predictions or inference outcomes performed at lower layers and the traffic-related outcomes to be derived at higher layers. For example, the configuration 108 may include filtering coefficients to be applied on lower-layer outputs to deliver higher-layer outcomes.

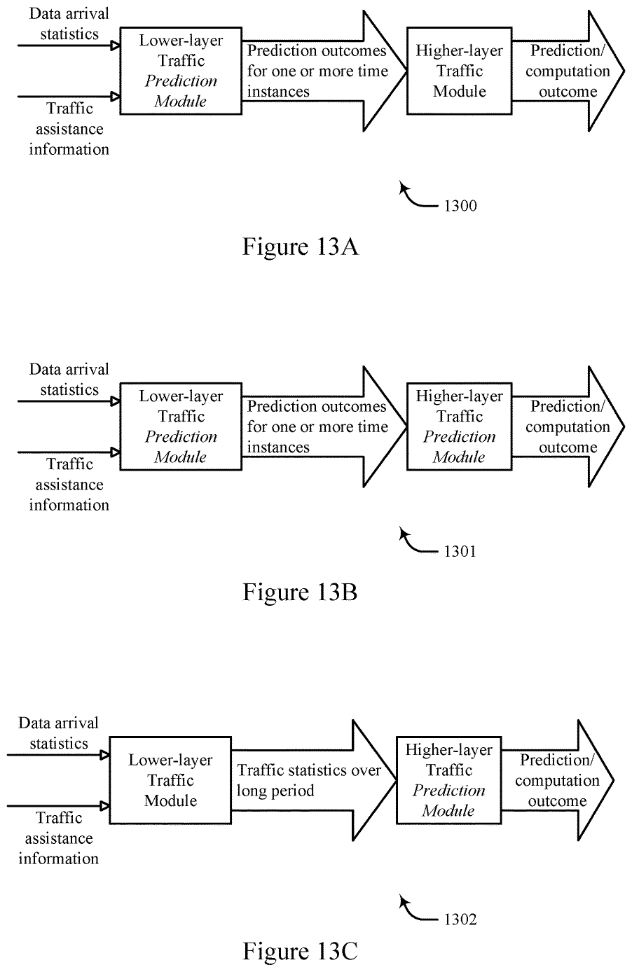

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a central processing unit (CPU), an ASIC, a field-programmable gate-array (FPGA), or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein. The UE 1400 may be configured to or operable to support a means for receiving control information including a field indicating a request for information associated with an uplink status to be reported for the UE, where the field further indicates a type of the uplink status corresponding to a current uplink status or a predicted uplink status, and transmitting, in response to the control information, an uplink status report including the information in accordance with the indicated type of the uplink status. In this manner, the UE 1400 supports on-demand uplink status reporting that enables the NE to obtain actual or predicted uplink status information at a time determined by the NE, reducing latency in evaluating prediction accuracy and improving the efficiency of uplink scheduling decisions.

Additionally, or alternatively, the UE 1400 may be configured to support any one or combination of the control information is signaled within DCI via a PDCCH. This aspect enables the NE to request uplink status information using existing downlink control signaling, reducing signaling overhead and allowing the request to be transmitted with low latency. Additionally, or alternatively, the UE 1400 may be configured to support any one or combination of the control information further indicates uplink resources for transmission of the uplink status report, and the uplink status report is transmitted on the indicated uplink resources. This aspect enables the NE to coordinate the request and the corresponding uplink resources in a single signaling exchange, reducing the delay between the request and the receipt of the uplink status report.

Additionally, or alternatively, the UE 1400 may be configured to support any one or combination of the control information is signaled within a MAC-CE. This aspect provides an alternative signaling mechanism for requesting uplink status information, enabling flexibility in how the NE communicates the request to the UE 1400. Additionally, or alternatively, the UE 1400 may be configured to support any one or combination of the field further indicates a category of the uplink status, the category corresponding to at least one of a buffer status, a delay status, or a power status. This aspect enables the NE to request specific categories of uplink status information that are relevant to the uplink scheduler at a given time, reducing unnecessary signaling and improving scheduling efficiency.

Additionally, or alternatively, the UE 1400 may be configured to support any one or combination of the field includes a set of bits, each bit of the set of bits corresponding to a respective category of the uplink status. This aspect provides a flexible and compact mechanism for the NE to request one or more categories of uplink status information in a single control signaling exchange. Additionally, or alternatively, the UE 1400 may be configured to support any one or combination of the type corresponds to the current uplink status, and the information is calculated based on data currently pending in a layer 2 buffer of the UE 1400. This aspect enables the NE to obtain an accurate view of the UE 1400's current buffer occupancy, supporting scheduling decisions based on actual data pending for transmission.

Additionally, or alternatively, the UE 1400 may be configured to support any one or combination of the type corresponds to the predicted uplink status, and the information is predicted for a future time instance based on an inference outcome of a traffic prediction model. This aspect enables the NE to obtain predicted uplink status information on demand, supporting proactive scheduling decisions based on anticipated future traffic arrivals. Additionally, or alternatively, the UE 1400 may be configured to support any one or combination of the uplink status includes a power status based on a reference uplink allocation. This aspect enables the NE to obtain power headroom information that reflects expected uplink transmission conditions, improving the accuracy of uplink resource allocation.

Additionally, or alternatively, the UE 1400 may be configured to support any one or combination of the reference uplink allocation includes a reference PUSCH format configured by the network node, and the UE 1400 computes a power headroom value for the reference PUSCH format, the power headroom value computed using an MPR value determined by the UE 1400 for the reference PUSCH format. This aspect provides the NE with early power headroom information that accounts for actual power back-off conditions, enabling the NE to adapt its scheduling strategy and provide efficient uplink scheduling at the beginning of a data burst. Additionally, or alternatively, the UE 1400 may be configured to support any one or combination of the control information further indicates a reference PUSCH format from a preconfigured set of reference PUSCH formats for computation of the power status. This aspect enables the NE to specify which reference PUSCH format the UE 1400 should use for computing the power headroom, improving the relevance of the reported power status to the expected uplink transmission conditions.

Additionally, or alternatively, the UE 1400 may be configured to support any one or combination of refraining from transmitting the uplink status report for the current uplink status based on a prior transmission of the uplink status report for the predicted uplink status and receipt of an uplink grant, where the uplink grant is based on the predicted uplink status. This aspect reduces signaling overhead by avoiding redundant reporting when the NE has already allocated resources based on the predicted uplink status. Additionally, or alternatively, the UE 1400 may be configured to support any one or combination of the control information further indicates a prediction window, and the information is predicted for the prediction window. This aspect enables the NE to specify the time horizon for which the UE 1400 should generate predictions, allowing the NE to tailor the prediction scope to its scheduling needs. Additionally, or alternatively, the UE 1400 may be configured to support any one or combination of the control information indicates an enablement or disablement of predictive uplink status reporting at the UE 1400. This aspect enables the NE to dynamically control whether the UE 1400 performs predictive reporting, allowing the NE to selectively enable or disable predictive reporting based on prediction accuracy or network conditions.

Additionally, or alternatively, the UE 1400 may support at least one memory (e.g., the memory 1404) and at least one processor (e.g., the processor 1402) coupled with the at least one memory and configured to cause the UE 1400 to receive control information including a field indicating a request for information associated with an uplink status of the UE 1400, where the field further indicates a type of the uplink status corresponding to a current uplink status or a predicted uplink status, and transmit, in response to the control information, an uplink status report including the information in accordance with the indicated type of the uplink status. In this manner, the UE 1400 supports on-demand uplink status reporting that enables the NE to obtain actual or predicted uplink status information at a time determined by the NE, reducing latency in evaluating prediction accuracy and improving the efficiency of uplink scheduling decisions.

Additionally, the UE 1400 may be configured to support any one or combination of the control information is signaled within DCI via a PDCCH. This aspect enables the NE to request uplink status information using existing downlink control signaling, reducing signaling overhead and allowing the request to be transmitted with low latency. Additionally, or alternatively, the UE 1400 may be configured to support any one or combination of the control information further indicates uplink resources for transmission of the uplink status report, and the uplink status report is transmitted on the indicated uplink resources. This aspect enables the NE to coordinate the request and the corresponding uplink resources in a single signaling exchange, reducing the delay between the request and the receipt of the uplink status report.

Additionally, or alternatively, the UE 1400 may be configured to support any one or combination of the control information is signaled within a MAC-CE. This aspect provides an alternative signaling mechanism for requesting uplink status information, enabling flexibility in how the NE communicates the request to the UE 1400. Additionally, or alternatively, the UE 1400 may be configured to support any one or combination of the field further indicates a category of the uplink status, the category corresponding to at least one of a buffer status, a delay status, or a power status. This aspect enables the NE to request specific categories of uplink status information that are relevant to the uplink scheduler at a given time, reducing unnecessary signaling and improving scheduling efficiency.

Additionally, or alternatively, the UE 1400 may be configured to support any one or combination of the field includes a set of bits, each bit of the set of bits corresponding to a respective category of the uplink status. This aspect provides a flexible and compact mechanism for the NE to request one or more categories of uplink status information in a single control signaling exchange. Additionally, or alternatively, the UE 1400 may be configured to support any one or combination of the type corresponds to the current uplink status, and the information is calculated based on data currently pending in a layer 2 buffer of the UE 1400. This aspect enables the NE to obtain an accurate view of the UE 1400's current buffer occupancy, supporting scheduling decisions based on actual data pending for transmission.

Additionally, or alternatively, the UE 1400 may be configured to support any one or combination of the type corresponds to the predicted uplink status, and the information is predicted for a future time instance based on an inference outcome of a traffic prediction model. This aspect enables the NE to obtain predicted uplink status information on demand, supporting proactive scheduling decisions based on anticipated future traffic arrivals. Additionally, or alternatively, the UE 1400 may be configured to support any one or combination of the uplink status includes a power status based on a reference uplink allocation. This aspect enables the NE to obtain power headroom information that reflects expected uplink transmission conditions, improving the accuracy of uplink resource allocation.

Additionally, or alternatively, the UE 1400 may be configured to support any one or combination of the at least one processor is further operable to cause the UE 1400 to compute a power headroom value for the reference PUSCH format, the power headroom value computed using an MPR value determined by the UE 1400 for the reference PUSCH format. This aspect provides the NE with early power headroom information that accounts for actual power back-off conditions, enabling the NE to adapt its scheduling strategy and provide efficient uplink scheduling at the beginning of a data burst. Additionally, or alternatively, the UE 1400 may be configured to support any one or combination of the control information further indicates a reference PUSCH format from a preconfigured set of reference PUSCH formats for computation of the power status. This aspect enables the NE to specify which reference PUSCH format the UE 1400 should use for computing the power headroom, improving the relevance of the reported power status to the expected uplink transmission conditions.

Additionally, or alternatively, the UE 1400 may be configured to support any one or combination of the at least one processor is further operable to cause the UE 1400 to refrain from transmitting the uplink status report for the current uplink status based on a prior transmission of the uplink status report for the predicted uplink status and receipt of an uplink grant, where the uplink grant is based on the predicted uplink status. This aspect reduces signaling overhead by avoiding redundant reporting when the NE has already allocated resources based on the predicted uplink status. Additionally, or alternatively, the UE 1400 may be configured to support any one or combination of the control information further indicates a prediction window, and the information is predicted for the prediction window. This aspect enables the NE to specify the time horizon for which the UE 1400 should generate predictions, allowing the NE to tailor the prediction scope to its scheduling needs.

Additionally, or alternatively, the UE 1400 may be configured to support any one or combination of the control information indicates an enablement or disablement of predictive uplink status reporting at the UE 1400. This aspect enables the NE to dynamically control whether the UE 1400 performs predictive reporting, allowing the NE to selectively enable or disable predictive reporting based on prediction accuracy or network conditions.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

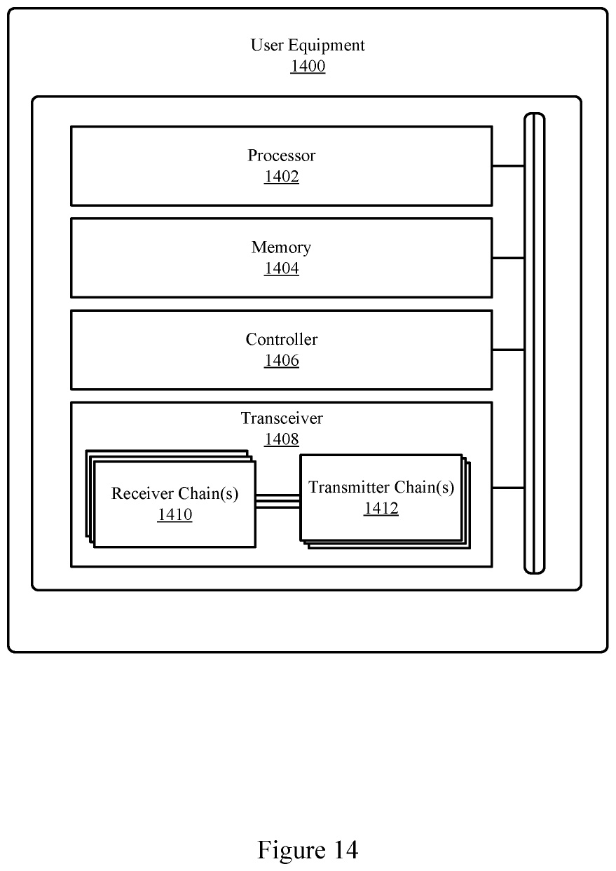

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine subsequent instruction(s) to be executed to cause the processor 1500 to support various operations in accordance with examples as described herein. The controller 1502 may be configured to track memory addresses of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs 1506, and other functional units of the processor 1500.

The memory 1504 may include one or more caches (e.g., memory local to or included in the processor 1500 or other memory, such as RAM, ROM, DRAM, SDRAM, SRAM, MRAM, flash memory, etc.). In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, and the controller 1502, and may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 may be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein. The processor 1500 may be configured to or operable to support at least one controller (e.g., the controller 1502) coupled with at least one memory (e.g., the memory 1504) and configured to cause the processor to receive control information including a field indicating a request for information associated with an uplink status, where the field further indicates a type of the uplink status corresponding to a current uplink status or a predicted uplink status, and transmit, in response to the control information, an uplink status report including the information in accordance with the indicated type of the uplink status. In this manner, the processor 1500 supports on-demand uplink status reporting that enables actual or predicted uplink status information to be obtained at a time determined by a requesting device, reducing latency in evaluating prediction accuracy and improving the efficiency of uplink scheduling decisions.

Additionally, the processor 1500 may be configured to or operable to support any one or combination of the control information is signaled within DCI via a PDCCH. This aspect supports requesting uplink status information using existing downlink control signaling, reducing signaling overhead and allowing the request to be transmitted with low latency. Additionally, or alternatively, the processor 1500 may be configured to or operable to support any one or combination of the control information further indicates uplink resources for transmission of the uplink status report, and the uplink status report is transmitted on the indicated uplink resources. This aspect supports coordinating the request and the corresponding uplink resources in a single signaling exchange, reducing the delay between the request and the receipt of the uplink status report.

Additionally, or alternatively, the processor 1500 may be configured to or operable to support any one or combination of the control information is signaled within a MAC-CE. This aspect provides an alternative signaling mechanism for requesting uplink status information, enabling flexibility in how the request is communicated. Additionally, or alternatively, the processor 1500 may be configured to or operable to support any one or combination of the field further indicates a category of the uplink status, the category corresponding to at least one of a buffer status, a delay status, or a power status. This aspect supports requesting specific categories of uplink status information that are relevant to the uplink scheduler at a given time, reducing unnecessary signaling and improving scheduling efficiency.

Additionally, or alternatively, the processor 1500 may be configured to or operable to support any one or combination of the field includes a set of bits, each bit of the set of bits corresponding to a respective category of the uplink status. This aspect provides a flexible and compact mechanism for requesting one or more categories of uplink status information in a single control signaling exchange. Additionally, or alternatively, the processor 1500 may be configured to or operable to support any one or combination of the type corresponds to the current uplink status, and the information is calculated based on data currently pending in a layer 2 buffer. This aspect supports obtaining an accurate view of current buffer occupancy, supporting scheduling decisions based on actual data pending for transmission.

Additionally, or alternatively, the processor 1500 may be configured to or operable to support any one or combination of the type corresponds to the predicted uplink status, and the information is predicted for a future time instance based on an inference outcome of a traffic prediction model. This aspect supports obtaining predicted uplink status information on demand, supporting proactive scheduling decisions based on anticipated future traffic arrivals. Additionally, or alternatively, the processor 1500 may be configured to or operable to support any one or combination of the uplink status includes a power status based on a reference uplink allocation. This aspect supports obtaining power headroom information that reflects expected uplink transmission conditions, improving the accuracy of uplink resource allocation.

Additionally, or alternatively, the processor 1500 may be configured to or operable to support any one or combination of the reference uplink allocation includes a reference PUSCH format, and the processor 1500 computes a power headroom value for the reference PUSCH format, the power headroom value computed using an MPR value determined for the reference PUSCH format. This aspect provides early power headroom information that accounts for actual power back-off conditions, enabling an adapted scheduling strategy and efficient uplink scheduling at the beginning of a data burst. Additionally, or alternatively, the processor 1500 may be configured to or operable to support any one or combination of the control information further indicates a reference PUSCH format from a preconfigured set of reference PUSCH formats for computation of the power status. This aspect supports specifying which reference PUSCH format should be used for computing the power headroom, improving the relevance of the reported power status to the expected uplink transmission conditions.

Additionally, or alternatively, the processor 1500 may be configured to or operable to support any one or combination of refraining from transmitting the uplink status report for the current uplink status based on a prior transmission of the uplink status report for the predicted uplink status and receipt of an uplink grant, where the uplink grant is based on the predicted uplink status. This aspect reduces signaling overhead by avoiding redundant reporting when resources have already been allocated based on the predicted uplink status. Additionally, or alternatively, the processor 1500 may be configured to or operable to support any one or combination of the control information further indicates a prediction window, and the information is predicted for the prediction window. This aspect supports specifying the time horizon for which predictions should be generated, allowing the prediction scope to be tailored to scheduling needs. Additionally, or alternatively, the processor 1500 may be configured to or operable to support any one or combination of the control information indicates an enablement or disablement of predictive uplink status reporting. This aspect supports dynamically controlling whether predictive reporting is performed, allowing predictive reporting to be selectively enabled or disabled based on prediction accuracy or network conditions.

Additionally, or alternatively, the processor 1500 may be configured to or operable to support at least one controller (e.g., the controller 1502) coupled with at least one memory (e.g., the memory 1504) and configured to cause the processor to transmit, to a UE, control information including a field indicating a request for information associated with an uplink status to be reported for the UE, where the field further indicates a type of the uplink status corresponding to a current uplink status or a predicted uplink status, and receive, from the UE, in response to the control information, an uplink status report including the information in accordance with the indicated type of the uplink status. In this manner, the processor 1500 supports network-initiated uplink status reporting that enables actual or predicted uplink status information to be obtained from a UE at a time determined by the requesting device, improving the accuracy of uplink scheduling decisions and enabling explicit monitoring of prediction performance.

Additionally, the processor 1500 may be configured to or operable to support any one or combination of the control information is signaled within DCI via a PDCCH. This aspect supports requesting uplink status information using existing downlink control signaling, reducing signaling overhead and allowing the request to be transmitted with low latency. Additionally, or alternatively, the processor 1500 may be configured to or operable to support any one or combination of the control information further indicates uplink resources for reception of the uplink status report, and the uplink status report is received on the indicated uplink resources. This aspect supports coordinating the request and the corresponding uplink resources in a single signaling exchange, reducing the delay between the request and the receipt of the uplink status report.

Additionally, or alternatively, the processor 1500 may be configured to or operable to support any one or combination of the control information is signaled within a MAC-CE. This aspect provides an alternative signaling mechanism for requesting uplink status information, enabling flexibility in how the request is communicated. Additionally, or alternatively, the processor 1500 may be configured to or operable to support any one or combination of the field further indicates a category of the uplink status, the category corresponding to at least one of a buffer status, a delay status, or a power status. This aspect supports requesting specific categories of uplink status information that are relevant to the uplink scheduler at a given time, reducing unnecessary signaling and improving scheduling efficiency.

Additionally, or alternatively, the processor 1500 may be configured to or operable to support any one or combination of the field includes a set of bits, each bit of the set of bits corresponding to a respective category of the uplink status. This aspect provides a flexible and compact mechanism for requesting one or more categories of uplink status information in a single control signaling exchange. Additionally, or alternatively, the processor 1500 may be configured to or operable to support any one or combination of the type corresponds to the current uplink status, and the information is calculated based on data currently pending in a layer 2 buffer. This aspect supports obtaining an accurate view of current buffer occupancy, supporting scheduling decisions based on actual data pending for transmission.

Additionally, or alternatively, the processor 1500 may be configured to or operable to support any one or combination of the type corresponds to the predicted uplink status, and the information is predicted for a future time instance based on an inference outcome of a traffic prediction model. This aspect supports obtaining predicted uplink status information on demand, supporting proactive scheduling decisions based on anticipated future traffic arrivals. Additionally, or alternatively, the processor 1500 may be configured to or operable to support any one or combination of the uplink status report includes a power status based on a reference uplink allocation. This aspect supports obtaining power headroom information that reflects expected uplink transmission conditions, improving the accuracy of uplink resource allocation.

Additionally, or alternatively, the processor 1500 may be configured to or operable to support any one or combination of the field further indicates a reporting granularity for the uplink status, the reporting granularity corresponding to at least one of a logical channel, a logical channel group, a QoS flow, or a QoS priority class. This aspect supports requesting uplink status information at a granularity that matches scheduling needs, providing visibility into the composition of traffic at a level of detail that may not be available with conventional BSR reporting at the LCG level alone. Additionally, or alternatively, the processor 1500 may be configured to or operable to support any one or combination of comparing the uplink status report for the current uplink status with a previously received uplink status report for the predicted uplink status to determine a prediction accuracy metric. This aspect supports unambiguous evaluation of prediction accuracy by directly comparing actual and predicted uplink status information, rather than inferring prediction accuracy from resource utilization patterns.

Additionally, or alternatively, the processor 1500 may be configured to or operable to support any one or combination of adapting a configuration for predictive uplink status reporting based on the prediction accuracy metric, or disabling predictive uplink status reporting based on the prediction accuracy metric failing to satisfy a threshold. This aspect supports selectively enabling, parameterizing, or disabling predictive reporting, so that prediction-based scheduling is used when it delivers sufficient performance gains. Additionally, or alternatively, the processor 1500 may be configured to or operable to support any one or combination of configuring a maximum frequency for transmitting the control information to control signaling overhead associated with prediction accuracy monitoring. This aspect supports balancing the need for prediction accuracy monitoring with the signaling overhead associated with requesting actual status reports. Additionally, or alternatively, the processor 1500 may be configured to or operable to support any one or combination of allocating uplink resources based on the uplink status report. This aspect supports performing scheduling decisions based on the received uplink status information, improving the efficiency and timeliness of uplink resource allocation.

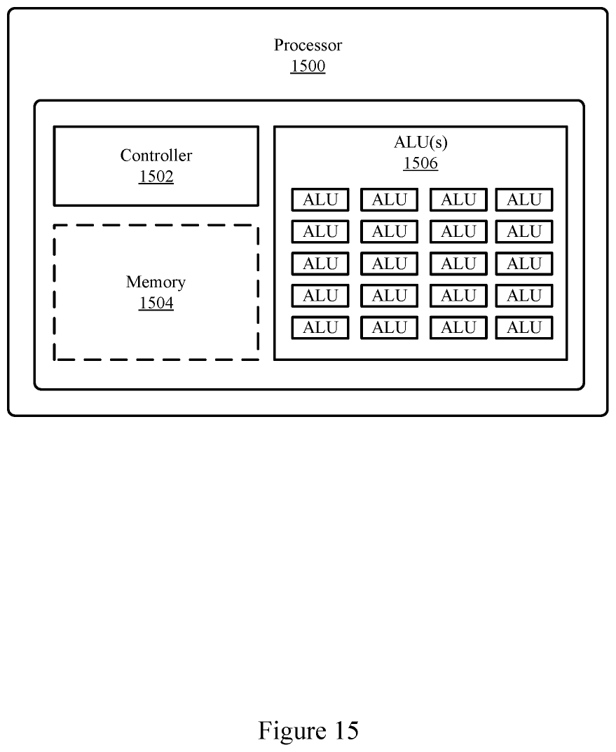

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein. The NE 1600 may be configured to or operable to support a means for transmitting, to a UE, control information including a field indicating a request for information associated with an uplink status to be reported for the UE, where the field further indicates a type of the uplink status corresponding to a current uplink status or a predicted uplink status, and receiving, from the UE, in response to the control information, an uplink status report including the information in accordance with the indicated type of the uplink status. In this manner, the NE 1600 supports network-initiated uplink status reporting that enables the NE 1600 to obtain actual or predicted uplink status information from the UE at a time determined by the NE 1600, improving the accuracy of uplink scheduling decisions and enabling explicit monitoring of prediction performance.

Additionally, or alternatively, the NE 1600 may be configured to support any one or combination of the control information is signaled within DCI via a PDCCH. This aspect enables the NE 1600 to request uplink status information using existing downlink control signaling, reducing signaling overhead and allowing the request to be transmitted with low latency. Additionally, or alternatively, the NE 1600 may be configured to support any one or combination of the control information further indicates uplink resources for reception of the uplink status report, and the uplink status report is received on the indicated uplink resources. This aspect enables the NE 1600 to coordinate the request and the corresponding uplink resources in a single signaling exchange, reducing the delay between the request and the receipt of the uplink status report.

Additionally, or alternatively, the NE 1600 may be configured to support any one or combination of the control information is signaled within a MAC-CE. This aspect provides an alternative signaling mechanism for requesting uplink status information, enabling flexibility in how the NE 1600 communicates the request to the UE. Additionally, or alternatively, the NE 1600 may be configured to support any one or combination of the field further indicates a category of the uplink status, the category corresponding to at least one of a buffer status, a delay status, or a power status. This aspect enables the NE 1600 to request specific categories of uplink status information that are relevant to the uplink scheduler at a given time, reducing unnecessary signaling and improving scheduling efficiency.

Additionally, or alternatively, the NE 1600 may be configured to support any one or combination of the field includes a set of bits, each bit of the set of bits corresponding to a respective category of the uplink status. This aspect provides a flexible and compact mechanism for the NE 1600 to request one or more categories of uplink status information in a single control signaling exchange. Additionally, or alternatively, the NE 1600 may be configured to support any one or combination of the type corresponds to the current uplink status, and the information is calculated based on data currently pending in a layer 2 buffer of the UE. This aspect enables the NE 1600 to obtain an accurate view of the UE's current buffer occupancy, supporting scheduling decisions based on actual data pending for transmission.

Additionally, or alternatively, the NE 1600 may be configured to support any one or combination of the type corresponds to the predicted uplink status, and the information is predicted for a future time instance based on an inference outcome of a traffic prediction model. This aspect enables the NE 1600 to obtain predicted uplink status information on demand, supporting proactive scheduling decisions based on anticipated future traffic arrivals. Additionally, or alternatively, the NE 1600 may be configured to support any one or combination of the uplink status report includes a power status based on a reference uplink allocation. This aspect enables the NE 1600 to obtain power headroom information that reflects expected uplink transmission conditions, improving the accuracy of uplink resource allocation.

Additionally, or alternatively, the NE 1600 may be configured to support any one or combination of the field further indicates a reporting granularity for the uplink status, the reporting granularity corresponding to at least one of a logical channel, a logical channel group, a QoS flow, or a QoS priority class. This aspect enables the NE 1600 to request uplink status information at a granularity that matches the scheduling needs, providing visibility into the composition of traffic at a level of detail that may not be available with conventional BSR reporting at the LCG level alone. Additionally, or alternatively, the NE 1600 may be configured to support any one or combination of comparing the uplink status report for the current uplink status with a previously received uplink status report for the predicted uplink status to determine a prediction accuracy metric. This aspect enables the NE 1600 to unambiguously evaluate the accuracy of the UE's predictions by directly comparing actual and predicted uplink status information, rather than inferring prediction accuracy from resource utilization patterns.

Additionally, or alternatively, the NE 1600 may be configured to support any one or combination of adapting a configuration for predictive uplink status reporting at the UE based on the prediction accuracy metric, or disabling predictive uplink status reporting at the UE based on the prediction accuracy metric failing to satisfy a threshold. This aspect enables the NE 1600 to selectively enable, parameterize, or disable predictive reporting per UE, so that prediction-based scheduling is used when it delivers sufficient performance gains. Additionally, or alternatively, the NE 1600 may be configured to support any one or combination of configuring a maximum frequency for transmitting the control information to control signaling overhead associated with prediction accuracy monitoring. This aspect enables the NE 1600 to balance the need for prediction accuracy monitoring with the signaling overhead associated with requesting actual status reports from the UE. Additionally, or alternatively, the NE 1600 may be configured to support any one or combination of allocating uplink resources for the UE based on the uplink status report. This aspect enables the NE 1600 to perform scheduling decisions based on the received uplink status information, improving the efficiency and timeliness of uplink resource allocation.

Additionally, or alternatively, the NE 1600 may support at least one memory (e.g., the memory 1604) and at least one processor (e.g., the processor 1602) coupled with the at least one memory and configured to cause the NE 1600 to transmit, to a UE, control information including a field indicating a request for information associated with an uplink status to be reported for the UE, where the field further indicates a type of the uplink status corresponding to a current uplink status or a predicted uplink status, and receive, from the UE, in response to the control information, an uplink status report including the information in accordance with the indicated type of the uplink status. In this manner, the NE 1600 supports network-initiated uplink status reporting that enables the NE 1600 to obtain actual or predicted uplink status information from the UE at a time determined by the NE 1600, improving the accuracy of uplink scheduling decisions and enabling explicit monitoring of prediction performance.

Additionally, the NE 1600 may be configured to support any one or combination of the control information is signaled within DCI via a PDCCH. This aspect enables the NE 1600 to request uplink status information using existing downlink control signaling, reducing signaling overhead and allowing the request to be transmitted with low latency. Additionally, or alternatively, the NE 1600 may be configured to support any one or combination of the control information further indicates uplink resources for reception of the uplink status report, and the uplink status report is received on the indicated uplink resources. This aspect enables the NE 1600 to coordinate the request and the corresponding uplink resources in a single signaling exchange, reducing the delay between the request and the receipt of the uplink status report.

Additionally, or alternatively, the NE 1600 may be configured to support any one or combination of the control information is signaled within a MAC-CE. This aspect provides an alternative signaling mechanism for requesting uplink status information, enabling flexibility in how the NE 1600 communicates the request to the UE. Additionally, or alternatively, the NE 1600 may be configured to support any one or combination of the field further indicates a category of the uplink status, the category corresponding to at least one of a buffer status, a delay status, or a power status. This aspect enables the NE 1600 to request specific categories of uplink status information that are relevant to the uplink scheduler at a given time, reducing unnecessary signaling and improving scheduling efficiency.

Additionally, or alternatively, the NE 1600 may be configured to support any one or combination of the field includes a set of bits, each bit of the set of bits corresponding to a respective category of the uplink status. This aspect provides a flexible and compact mechanism for the NE 1600 to request one or more categories of uplink status information in a single control signaling exchange. Additionally, or alternatively, the NE 1600 may be configured to support any one or combination of the type corresponds to the current uplink status, and the information is calculated based on data currently pending in a layer 2 buffer of the UE. This aspect enables the NE 1600 to obtain an accurate view of the UE's current buffer occupancy, supporting scheduling decisions based on actual data pending for transmission.

Additionally, or alternatively, the NE 1600 may be configured to support any one or combination of the type corresponds to the predicted uplink status, and the information is predicted for a future time instance based on an inference outcome of a traffic prediction model. This aspect enables the NE 1600 to obtain predicted uplink status information on demand, supporting proactive scheduling decisions based on anticipated future traffic arrivals. Additionally, or alternatively, the NE 1600 may be configured to support any one or combination of the uplink status report includes a power status based on a reference uplink allocation. This aspect enables the NE 1600 to obtain power headroom information that reflects expected uplink transmission conditions, improving the accuracy of uplink resource allocation.

Additionally, or alternatively, the NE 1600 may be configured to support any one or combination of the at least one processor is further operable to cause the NE 1600 to compare the uplink status report for the current uplink status with a previously received uplink status report for the predicted uplink status to determine a prediction accuracy metric. This aspect enables the NE 1600 to unambiguously evaluate the accuracy of the UE's predictions by directly comparing actual and predicted uplink status information, rather than inferring prediction accuracy from resource utilization patterns. Additionally, or alternatively, the NE 1600 may be configured to support any one or combination of the at least one processor is further operable to cause the NE 1600 to adapt a configuration for predictive uplink status reporting at the UE based on the prediction accuracy metric, or disable predictive uplink status reporting at the UE based on the prediction accuracy metric failing to satisfy a threshold. This aspect enables the NE 1600 to selectively enable, parameterize, or disable predictive reporting per UE, so that prediction-based scheduling is used when it delivers sufficient performance gains.

Additionally, or alternatively, the NE 1600 may be configured to support any one or combination of the at least one processor is further operable to cause the NE 1600 to configure a maximum frequency for transmitting the control information to control signaling overhead associated with prediction accuracy monitoring. This aspect enables the NE 1600 to balance the need for prediction accuracy monitoring with the signaling overhead associated with requesting actual status reports from the UE. Additionally, or alternatively, the NE 1600 may be configured to support any one or combination of the at least one processor is further operable to cause the NE 1600 to allocate uplink resources for the UE based on the uplink status report. This aspect enables the NE 1600 to perform scheduling decisions based on the received uplink status information, improving the efficiency and timeliness of uplink resource allocation.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., an LNA) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

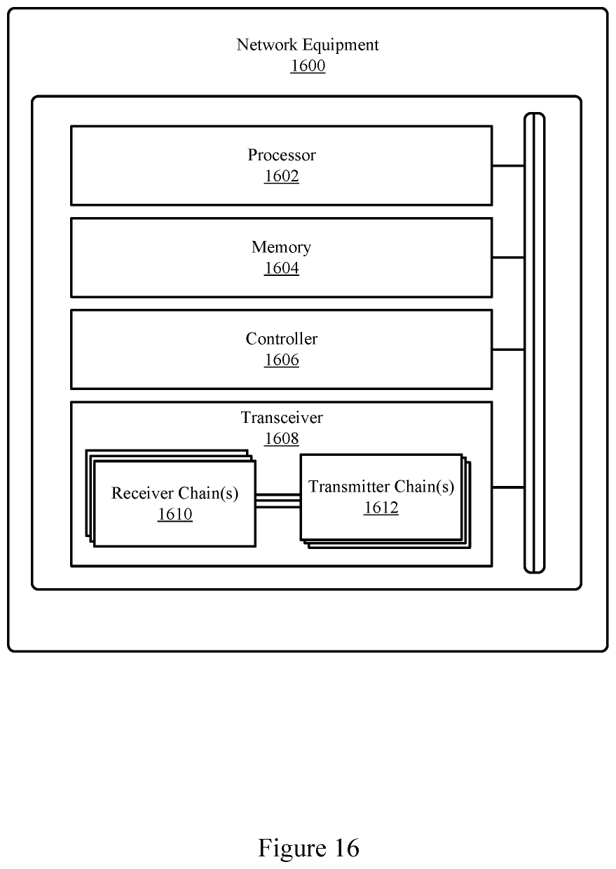

FIG. 17 illustrates a flowchart of a method 1700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1702, the method may include receiving control information including a field indicating a request for information associated with an uplink status to be reported for the UE, where the field further indicates a type of the uplink status corresponding to a current uplink status or a predicted uplink status. The operations of 1702 may be performed in accordance with examples as described herein. In some implementations, aspects of the operations of 1702 may be performed by a UE as described with reference to FIG. 14.

At 1704, the method may include transmitting, in response to the control information, an uplink status report including the information in accordance with the indicated type of the uplink status. The operations of 1704 may be performed in accordance with examples as described herein. In some implementations, aspects of the operations of 1704 may be performed by a UE as described with reference to FIG. 14.

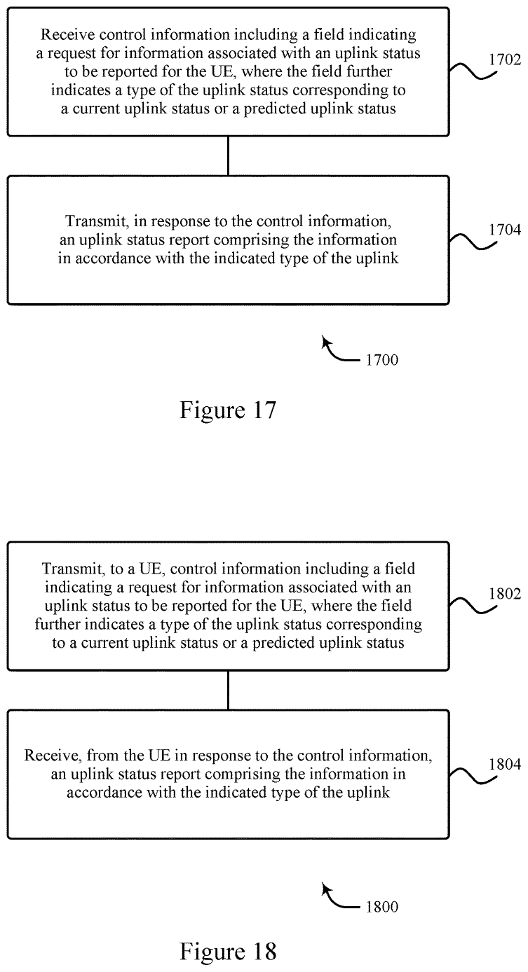

FIG. 18 illustrates a flowchart of a method 1800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1802, the method may include transmitting, to a UE, control information including a field indicating a request for information associated with an uplink status to be reported for the UE, where the field further indicates a type of the uplink status corresponding to a current uplink status or a predicted uplink status. The operations of 1802 may be performed in accordance with examples as described herein. In some implementations, aspects of the operations of 1802 may be performed by an NE as described with reference to FIG. 16.

At 1804, the method may include receiving, from the UE, in response to the control information, an uplink status report including the information in accordance with the indicated type of the uplink status. The operations of 1804 may be performed in accordance with examples as described herein. In some implementations, aspects of the operations of 1804 may be performed by an NE as described with reference to FIG. 16.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive control information including a field indicating a request for information associated with an uplink status to be reported for the UE, wherein the field further indicates a type of the uplink status corresponding to a current uplink status or a predicted uplink status; and
transmit, in response to the control information, an uplink status report comprising the information in accordance with the indicated type of the uplink status.

2. The UE of claim 1, wherein the control information is signaled within downlink control information (DCI) via a physical downlink control channel (PDCCH).

3. The UE of claim 2, wherein the control information further indicates uplink resources for transmission of the uplink status report, and wherein the uplink status report is transmitted on the indicated uplink resources.

4. The UE of claim 1, wherein the control information is signaled within a medium access control (MAC) control element (MAC-CE).

5. The UE of claim 1, wherein the field further indicates a category of the uplink status, the category corresponding to at least one of a buffer status, a delay status, or a power status.

6. The UE of claim 5, wherein the field comprises a plurality of bits, each bit of the plurality of bits corresponding to a respective category of the uplink status.

7. The UE of claim 1, wherein the type corresponds to the current uplink status, and wherein the at least one processor is further operable to cause the UE to generate the information based at least in part on data pending in a layer 2 buffer of the UE.

8. The UE of claim 1, wherein the type corresponds to the predicted uplink status, and wherein the at least one processor is further operable to cause the UE to generate a prediction for a future time instance based at least in part on an inference outcome of a traffic prediction model.

9. The UE of claim 1, wherein the uplink status comprises a power status based at least in part on a reference uplink allocation.

10. The UE of claim 9, wherein the reference uplink allocation comprises a reference physical uplink shared channel (PUSCH) format configured by a network node, and wherein the at least one processor is further operable to cause the UE to compute a power headroom value for the reference PUSCH format, the power headroom value computed using a maximum power reduction (MPR) value determined by the UE for the reference PUSCH format.

11. The UE of claim 1, wherein the at least one processor is further operable to cause the UE to refrain from transmitting the uplink status report for the current uplink status based at least in part on a prior transmission of the uplink status report for the predicted uplink status and receipt of an uplink grant, wherein the uplink grant is based at least in part on the predicted uplink status.

12. A network equipment (NE) for wireless communication, comprising:
at least one memory; and
at least one processor coupled with the at least one memory and operable to cause the NE to:
transmit, to a user equipment (UE), control information including a field indicating a request for information associated with an uplink status to be reported for the UE, wherein the field further indicates a type of the uplink status corresponding to a current uplink status or a predicted uplink status; and
receive, from the UE in response to the control information, an uplink status report comprising the information in accordance with the indicated type of the uplink status.

13. The NE of claim 12, wherein the control information is signaled within downlink control information (DCI) via a physical downlink control channel (PDCCH).

14. The NE of claim 13, wherein the control information further indicates uplink resources for reception of the uplink status report, and wherein the uplink status report is transmitted on the indicated uplink resources.

15. The NE of claim 12, wherein the control information is signaled within a medium access control (MAC) control element (MAC-CE).

16. The NE of claim 12, wherein the field further indicates a category of the uplink status, the category corresponding to at least one of a buffer status, a delay status, or a power status.

17. The NE of claim 12, wherein the at least one processor is further operable to cause the NE to compare the uplink status report for the current uplink status with a previously received uplink status report for the predicted uplink status to determine a prediction accuracy metric.

18. The NE of claim 17, wherein the at least one processor is further operable to cause the NE to at least one of:
adapt a configuration for predictive uplink status reporting at the UE based at least in part on the prediction accuracy metric; or
disable the predictive uplink status reporting at the UE based at least in part on the prediction accuracy metric failing to satisfy a threshold.

19. A method performed by a user equipment (UE), the method comprising:
receiving control information including a field indicating a request for information associated with an uplink status to be reported for the UE, wherein the field further indicates a type of the uplink status corresponding to a current uplink status or a predicted uplink status; and
transmitting, in response to the control information, an uplink status report comprising the information in accordance with the indicated type of the uplink status.

20. A method performed by a network equipment (NE), the method comprising:
transmitting, to a user equipment (UE), control information including a field indicating a request for information associated with an uplink status to be reported for the UE, wherein the field further indicates a type of the uplink status corresponding to a current uplink status or a predicted uplink status; and
receiving, from the UE in response to the control information, an uplink status report comprising the information in accordance with the indicated type of the uplink status.
